(19) United States
(12) Patent Application Publication
(10) Pub. No.: US 2003/0207089 A1
(43) Pub. Date: Nov. 6, 2003

(54) Electrophotographic image-receiving sheet, process for manufacturing the same, and process for image formation using the same

(75) Inventors: Yoshisada Nakamura, Shizuoka (JP); Yoshio Tani, Shizuoka (JP)

Correspondence Address: SUGHRUE MION, PLLC, 2100 PENNSYLVANIA AVENUE, N.W., WASHINGTON, DC, 20037, US

(73) Assignee: Fuji Photo Film Co., Ltd.

(21) Appl. No.: 10/426,656

(22) Filed: May 1, 2003

(30) Foreign Application Priority Data
May 1, 2002 (JP) 2002-129655
Aug. 23, 2002 (JP) 2002-242876
Dec. 18, 2002 (JP) 2002-367100

(51) Int. Cl. B32B 3/00

(52) U.S. Cl. 428/195.1

(57) ABSTRACT

The present invention aims to provide an electrophotographic image-receiving sheet which gives a good, high-gloss image and has a toner image-receiving layer with improved brittleness. The electrophotographic image-receiving sheet includes a support, a toner image-receiving layer which contains a thermoplastic resin and is disposed on at least one surface of the support, and an intermediate layer which contains a thermoplastic resin and is disposed between the support and the toner image-receiving layer. In the electrophotographic image-receiving sheet, a glass transition temperature of the thermoplastic resin in the toner image-receiving layer is 35° C. or more and is higher than a glass transition temperature of the thermoplastic resin in the intermediate layer, and the toner image-receiving layer contains less than 40% by mass of a pigment, based on an amount of the thermoplastic resin in mass in the toner image-receiving layer.

### BACKGROUND OF THE INVENTION

1. Field of the Invention

The present invention relates to an electrophotographic image-receiving sheet which gives a high-gloss image and has a toner image-receiving layer with improved brittleness, to a process for manufacturing the electrophotographic image-receiving sheet, and to a process for image formation using the electrophotographic image-receiving sheet.

2. Description of the Related Art

In general commercial printing and high-class printing, offset printing is in common use. Treated paper such as art paper and coated paper, is used. This is because the surface of the coated paper is smooth, therefore, transfer properties of ink are good, image reproducibility is high, image gloss is high and color reproducibility is good.

However, the coating layer of the coated paper contains a large amount of pigment, and is highly hygroscopic. Therefore, if coated paper is used as an electrophotographic image-receiving sheet as it is, when an image is fixed by heat, the steam in the coated paper expands and blistering (swelling of the coating layer) occurs between the raw paper and coating layer. Consequently, the image becomes coarse, and finely detailed image quality such as is obtained with a silver halide photograph, cannot be obtained. Also, in the coated paper of the related art, when outputting image information such as a face or scenery in the same way as a photograph, brilliance deteriorates.

For example, an electrophotographic image-receiving sheet material having excellent brilliance, which has one or more layers including a toner image-receiving layer on a support, is disclosed by Japanese Patent Application Laid-Open (JP-A) No. 2000-352834. However, in the electrophotographic image-receiving sheet material, the support used therein is a coated paper, and is still not sufficient in respect of heat-resistance and brilliance.

An image-receiving sheet for color electrophotography comprising a toner image-receiving layer on the surface of a base sheet via an underlayer, and having moderate surface brilliance with high color saturation, is disclosed in JP-A No. 07-271079.

However, the toner image-receiving layer uses a polyester resin having a glass transition temperature of 30° C. or less. When the toner image-receiving layer is coated on a support, the brittleness of the toner image-receiving layer deteriorates, unevenness arises on the surface of the toner image-receiving layer, and the image properties of the toner image-receiving layer deteriorate.

### SUMMARY OF THE INVENTION

It is therefore an object of the present invention to provide an electrophotographic image-receiving sheet which gives a good, high-gloss image and has a toner image-receiving layer with improved brittleness, a process for manufacturing the electrophotographic image-receiving sheet, and a process for image formation using the electrophotographic image-receiving sheet.

The inventors of the present invention have discovered that, by coating an intermediate layer having a small amount of pigment on the surface of the support when the toner image-receiving layer is disposed, the irregularity on a surface of the support could be smoothed, and by disposing a toner image-receiving layer containing a thermoplastic resin having a specific glass transition temperature with a small amount of pigment on the surface of the intermediate layer, the brilliance increased and the brittleness of the toner image-receiving layer is largely improved.

The electrophotographic image-receiving sheet of the present invention comprises a support, a toner image-receiving layer which contains a thermoplastic resin and is disposed on at least one surface of the support, and an intermediate layer which contains a thermoplastic resin and is disposed between the support and the toner image-receiving layer. In the electrophotographic image-receiving sheet of the present invention, a glass transition temperature of the thermoplastic resin in the toner image-receiving layer is 35° C. or more and is higher than a glass transition temperature of the thermoplastic resin in the intermediate layer, and the toner image-receiving layer contains less than 40% by mass of a pigment, based on an amount of the thermoplastic resin in mass in the toner image-receiving layer. Due to this, the unevenness on the surface of the support can be smoothed, therefore, when the toner image-receiving layer containing the thermoplastic resin having a specific glass transition temperature with a small amount of pigment is provided on the intermediate layer, brilliance is increased, and the brittleness of the toner image-receiving layer is largely improved.

The process for image formation of the present invention comprises the step forming a toner image on an electrophotographic image-receiving sheet, the step of heating and pressurizing a surface of the electrophotographic image-receiving sheet on which the toner image is formed by a fixing belt and a fixing roller, and the step of cooling the surface so as to separate the electrophotographic image-receiving sheet from the fixing belt. Hence, even if an oil-less machine without any fixing oil is used, separation of the electrophotographic image-receiving sheet and toner, or offset of the electrophotographic image-receiving sheet and toner, can be prevented, a smooth paper feed can be realized, and a good image having unprecedented gloss which is rich in photographic texture, can be obtained.

### BRIEF DESCRIPTION OF THE DRAWINGS

FIG. 1 is a schematic view showing an example of the fixing area of an apparatus for electrophotography according to the present invention.

FIG. 2 is a schematic view showing an example of the fixing part of the apparatus for electrophotography used in the Examples in the present invention.

### DESCRIPTION OF THE PREFERRED EMBODIMENTS

(Electrophotographic Image-Receiving Sheet)

The electrophotographic image-receiving sheet of the present invention comprises a support, a toner image-receiving layer on at least one surface of the support, and an intermediate layer between the support and the toner image-receiving layer. It may also comprise other layers suitably selected according to the purpose. The other layers may be a surface protection layer, undercoat, cushion layer, charge control (prevention) layer, reflecting layer, color tone preparation layer, storage property improvement layer, adhesion prevention layer, anticurl layer and smoothing layer, or the like. These layers may have single-layer structures, or may have a laminated structure.

[Support]

There is no particular limitation on the support as long as it can be resistant to the fixing temperature, and satisfies the requirements such as smoothness, whiteness index, sliding properties, frictional properties and antistatic properties, and it may be suitably selected according to the purpose. Examples of the support include raw paper, synthetic paper, synthetic resin sheet, coated paper and laminated paper and the like. These supports may have a single-layer structure, or may have a laminated structure of two or more layers.

The raw paper may be a high quality paper, for example, the paper described in Basic Photography Engineering—Silver Halide Photography, CORONA PUBLISHING CO., LTD. (1979) pp. 223-240, edited by the Institute of Photography of Japan.

The materials of the raw paper (including synthetic paper) may be those types of raw paper used as supports in the art, which can be selected from various kinds of materials without any particular limitation. Examples of the materials of the raw paper include natural pulp selected from needle-leaf trees and broadleaf trees, synthetic pulp made from plastics materials such as polyethylene, polypropylene, or the like, a mixture of the natural pulp and the synthetic pulp, and the like.

Regarding pulps used as materials for raw paper, from the viewpoint of good balance between surface flatness and smoothness of the raw paper, rigidity and dimensional stability (curl), broadleaf tree bleached kraft pulp (LBKP) is preferred. Needle-leaf bleached kraft pulp (NBKP), broadleaf tree sulfite pulp (LBSP), or the like can also be used.

The pulp can be beated by beater of refiner.

Canadian standard freeness of the pulp is preferably 200 ml C.S.F to 440 ml C.S.F, and more preferably 250 ml C.S.F to 380 ml C.S.F, from the viewpoint of controlling contraction of paper at a paper-manufacturing step.

Various additives, for example, fillers, dry paper reinforcers, sizing agents, wet paper reinforcers, fixing agents, pH regulators or other agents, or the like may be added, if necessary, to the pulp slurry (hereafter, may be referred to as pulp paper material) which is obtained after beating the pulp.

Examples of the fillers include calcium carbonate, clay, kaolin, white clay, talc, titanium oxide, diatomaceous earth, barium sulfate, aluminum hydroxide, magnesium hydroxide, and the like.

Examples of the dry paper reinforcers include cationic starch, cationic polyacrylamide, anionic polyacrylamide, amphoteric polyacrylamide, carboxy-modified polyvinyl alcohol, and the like.

Examples of the sizing agents include rosin derivatives such as aliphatic salts, rosin, maleic rosin or the like; paraffin wax, alkyl ketene dimer, alkenyl succinic anhydride (ASA), epoxy aliphatic amide, and the like.

Examples of the wet paper reinforcers include polyamine polyamide epichlorohydrin, melamine resin, urea resin, epoxy polyamide resin, and the like.

Examples of the fixing agents include polyfunctional metal salts such as aluminum sulfate, aluminum chloride, or the like; cationic polymers such as cationic starch, or the like.

Examples of the pH regulators include caustic soda, sodium carbonate, and the like. Examples of other agents include defoaming agents, dyes, slime control agents, fluorescent whitening agents, and the like.

Moreover, softeners can also be added if necessary. An example of the softeners is indicated on pp. 554-555 of Paper and Paper Treatment Manual (Shiyaku Time Co., Ltd.) (1980).

Treatment liquids used for sizing a surface may include water-soluble polymers, waterproof materials, pigments, dyes, fluorescent whitening agents, and the like. Examples of water-soluble polymers include cationic starch, polyvinyl alcohol, carboxy-modified polyvinyl alcohol, carboxymethylcellulose, hydroxyethylcellulose, cellulose sulfite, gelatin, casein, sodium polyacrylate, styrene-maleic anhydride copolymer sodium salt, sodium polystyrene sulfonate, and the like.

Examples of the waterproof materials include latex emulsions such as styrene-butadiene copolymer, ethylene-vinyl acetate copolymer, polyethylene, vinylidene chloride copolymer or the like; polyamide polyamine epichlorohydrin, and the like.

Examples of the pigments include calcium carbonate, clay, kaolin, talc, barium sulfate, titanium oxide, and the like.

Examples of the raw paper materials include the natural pulps, synthetic pulp paper, mixtures of the natural pulp and the synthetic pulp, various types of composite paper, and the like.

As for the above raw paper, to improve the rigidity and dimensional stability (curl) of the electrophotographic image-receiving paper, it is preferred that the ratio (Ea/Eb) of the longitudinal Young's modulus (Ea) and the lateral Young's modulus (Eb) is within the range of 1.5 to 2.0. If the ratio (Ea/Eb) is less than 1.5 or more than 2.0, the rigidity and curl of the electrophotographic image-receiving paper tend to deteriorate, and may interfere with paper when transported.

In the present invention, the Oken type smoothness of a surface of the toner image-receiving layer of the raw paper is 210 seconds or more, and preferably 250 seconds or more. If the Oken type smoothness is less than 210 seconds, the quality of the toner image is poor. There is no particular limitation on the upper limit. However, in practice, about 600 seconds, and preferably about 500 seconds are suitable.

Here, the Oken type smoothness refers to the smoothness specified by the JAPAN TAPPI No. 5B method.

It has been found that, in general, the “tone” of the paper differs based on differences in the way the paper is beaten, and the elasticity (modulus) of paper from paper-making after beating can be used as an important indication of the “tone” of the paper.

The elastic modulus of the paper can be calculated from the following equation by using the relation of the density and the dynamic modulus which shows the physical properties of a viscoelastic object, and by measuring the velocity of sound propagation in the paper using an ultrasonic oscillator.

E=ρc²(1−n²)

[E=dynamic modulus, ρ=density, c=velocity of sound in paper, n=Poisson's ratio]

As n=0.2 or so in a case of ordinary paper, there is not much difference in the calculation, even if the calculation is performed by the following equation:

E=ρc²

Namely, if the density of the paper and acoustic velocity can be measured, the elastic modulus can easily be calculated. In the above equation, when measuring acoustic velocity, various instruments known in the art may be used, such as a Sonic Tester SST-110 (Nomura Shoji Co., Ltd.) or the like.

The thickness of the raw paper is preferably 30 μm to 500 μm, and more preferably 50 μm to 300 μm, and still more preferably 100 μm to 250 μm. The weighting of the raw paper is for example preferably 50 g/m² to 250 g/m², and more preferably 100 g/m² to 200 g/m².

In the raw paper, it is preferred to use pulp fibers having a fiber length distribution as disclosed, for example, in Japanese Patent Application Laid-Open (JP-A) No. 58-68037 (for example, the sum of 24-mesh screen residue and 42-mesh screen residue is 20% by mass to 45% by mass, and 24-mesh screen residue is 5% by mass or less) in order to give the desired center line average roughness to the surface. Moreover, the center line average roughness can be adjusted by heating and giving a pressure to a surface of the raw paper, with a machine calendar, super calendar, or the like.

Synthetic Resin Sheet

The synthetic resin sheet may be a synthetic resin formed in the shape of a sheet (film). The synthetic resin sheet may for example be obtained by extrusion molding polyolefin resin such as polypropylene resin or the like, or polyester resins such as polyethylene-terephthalate resin, or the like, into a shape of a sheet.

Coated Paper

The coated paper is paper or a sheet on one surface or both surfaces of which rubber latex, polymer materials, or the like is coated. The amount to be coated differs according to the use. Examples of the coated paper include art paper, cast coated paper, Yankee paper, and the like.

If a resin is used to coat the surface of raw paper, for example, it is appropriate to use a thermoplastic resin. Examples of the thermoplastic resins include the thermoplastic resins of the following (a) to (h).

(a) Polyolefin resins such as polyethylene resin, polypropylene resin, or the like; copolymer resins of an olefin such as ethylene or propylene with other vinyl monomers; acrylic resins, and the like.

(b) Thermoplastic resins containing at least an ester bond. For example, polyester resins obtained by condensation of dicarboxylic acid components (these dicarboxylic acid components may be substituted by a sulfonic acid group, a carboxyl group, and the like.) and alcoholic components (these alcoholic components may be substituted by the hydroxyl group, and the like), polyacrylic acid ester resins or polymethacrylic acid ester resins such as polymethylmethacrylate, polybutylmethacrylate, polymethylacrylate, polybutylacrylate, and the like; polycarbonate resin, polyvinyl acetate resin, styrene acrylate resin, styrene-methacrylic acid ester copolymer resin, vinyltoluene acrylate resin, and the like.

Specifically, the resins described in JP-A Nos. 59-101395, 63-7971, 63-7972, 63-7973, 60-294862, or the like may be mentioned.

Examples of commercial products include Bailon 290, Bailon 200, Bailon 280, Bailon 300, Bailon 103, Bailon GK-140 and Bailon GK-130 from Toyobo Co., Ltd; Tufton NE-382, Tufton U-5, ATR-2009 and ATR-2010 from Kao Corporation; Eritel UE3500, UE3210, XA-8153, KZA-7049 and KZA-1449 from Unitika Ltd.; polyester-TP-220 and R-188 from The Nippon Synthetic Chemical Industry Co., Ltd.; and thermoplastic resins in the high loss series from SEIKO CHEMICAL INDUSTRIES CO., LTD., and the like.

(c) Polyurethane resins, and the like.

(d) Polyamide resins, urea resins, and the like.

(e) Polysulfone resins, and the like.

(f) Polyvinyl chloride resin, polyvinylidene chloride resin, vinyl chloride-vinyl acetate-copolymer resin, vinyl chloride-vinyl propionate copolymer resin, and the like.

(g) Polyol resins such as polyvinyl butyral, and cellulose resins such as ethyl cellulose resin and cellulose acetate resin.

(h) Polycaprolactone resin, styrene-maleic anhydride resin, polyacrylonitrile resin, polyether resins, epoxy resins, phenol resins, and the like.

One of the thermoplastic resins may be used either alone or in combination of two or more.

A thickness of the thermoplastic resin layer is preferably 5 μm to 100 μm, and more preferably 15 μm to 50 μm. A thermoplastic resin layer disposed on a surface of paper and a thermoplastic resin layer disposed on a back surface of the paper may have either the same or different components, physical properties, thickness, and structure.

Laminated Paper

The laminated paper comprises various kinds of sheets, films, or layers of resins, rubber, polymer, or the like on a sheet such as raw paper or the like. Examples of laminating materials (resins, rubber, polymer, or the like) include polyolefin, polyvinyl chloride, polyethylene terephthalate, polystyrene, polymethacrylate, polycarbonate, polyimide, triacetyl cellulose, and the like. These resins may be used either alone or in combination of two or more.

The polyolefin is generally formed using a low density polyethylene. In order to improve the heat-resistance properties of the support, it is preferred to use polypropylene, a blend of polypropylene and polyethylene, high density polyethylene, a blend of high density polyethylene and low density polyethylene, or the like. From the viewpoints of cost and suitability for lamination, it is most preferred to use the blend of high density polyethylene and low density polyethylene.

The blend of high density polyethylene and low density polyethylene is used in a blending ratio (mass ratio) of, for example, 1/9 to 9/1. This blending ratio is preferably 2/8 to 8/2, and more preferably 3/7 to 7/3. When disposing a thermoplastic resin layer on both surfaces of the support, it is preferred to use high density polyethylene, or the blend of high density polyethylene and low density polyethylene, on the back surface of the support. There is no particular limitation on the molecular weight of polyethylene. However, it is preferred that the melt index is within 1.0 g/10 minutes to 40 g/10 minutes for both high density polyethylene and low density polyethylene, and is preferred that it has extrusion suitability.

In addition, a treatment may be performed to confer white reflective properties on these sheets or films. An example of such a treatment method is to blend a pigment such as titanium oxide or the like into these sheets or films.

The resin used for coating or laminating is not limited to a thermoplastic resin. Examples of the resins for coating or laminating further include a resin in which monomer or thermoplastic resin is reacted with light, hardeners, cross-linking agents, or the like, thermosetting resin, and the like.

At least one layer of the coating or laminated resin layers may be a monomer containing a photopolymerization initiator, or may be a resin composition cured by UV irradiation. The resin composition may in this case contain an electron beam-hardening organic compound as a main component. There is no particular limitation on the type of this electron-beam hardening organic compound, which may be a monomer or an oligomer. These may be used either alone or in combination of two or more.

The electron-beam hardening unsaturated compound may for example be selected from the following compounds.

(1) Acrylate compounds of aliphatic, alicyclic or aromatic-aliphatic monovalent to sixivalent alcohols and polyalkylene glycols

(2) Acrylate compounds obtained by adding alkylene oxides to aliphatic, alicyclic or aromatic-aliphatic monovalent to sixivalent alcohols

(3) Polyacryloylalkyl phosphate esters

(4) Reaction products of carboxylic acids, polyols, and acrylic acid

(5) Reaction products of isocyanates, polyols, and acrylic acid

(6) Reaction products of epoxy compounds and acrylic acid

(7) Reaction products of epoxy compounds, polyols, and acrylic acid.

Examples of these compounds, or specifically, examples of the electron-beam hardening unsaturated organic compound, include polyoxyethylene epichlorohydrin-modified bisphenol A diacrylate, dicyclohexyl acrylate, epichlorohydrin-modified polyethylene glycol diacrylate, 1,6-hexanediol diacrylate, hydroxybivaric acid ester neopentyl glycol diacrylate, nonyl phenoxypolyethylene glycol acrylate, ethylene oxide-modified phenoxyic phosphoric acid acrylate, ethylene oxide-modified phthalic acid acrylate, polybutadiene acrylate, caprolactam-modified tetrahydrofurfuryl acrylate, tris(acryloxyethyl) isocyanate, trimethylol-propane triacrylate, pentaerythritol triacrylate, pentaerythritol tetraacrylate, pentaerythritol penta-acrylate, dipentaaerythritol hexaacrylate, polyethylene glycol diacrylate, 1,4-butadiene diol diacrylate, neopentyl glycol diacrylate, neo pentyl glycol-modified trimethylolpropane diacrylate, and the like.

These organic compounds may be used either alone or in combination of two or more.

Regarding the coating or laminated resin layer, there is no particular limitation on the type of WV radiation hardening organic compound which becomes cured by UV irradiation. The UV radiation hardening resin composition may be prepared by adding a suitable amount of the photopolymerization initiator to the electron-beam hardening resin. The resin composition used for electron-beam hardening may or may not contain a photopolymerization initiator, and it is preferable to use it to the extent that it does not generate odor.

Examples of the photopolymerization initiator include acetophenone such as ethyl anthraquinone, methyl benzoyl formate, 1-hydroxy cyclohexylphenylketone, anthophenone, diethoxyacethophenone, trichloroacetophenone, or the like; o-benzoylmethylbenzoate, benzophenone, Michler's ketone, benzyl, benzoin, benzoin alkyl ether, benzyl dimethyl ketal, tetramethyl thorium monosulfide, xanthone, thioxanthone, benzophenone, azo compounds, and the like. These can be used either alone or in combination of two or more.

The amount to add the photopolymerization initiator is preferably 0.1% by mass to 10% by mass relative to the mass of UV radiation hardening resin. The concurrent use of photopolymerization promoters known in the art such as N-methyldiethanolamine, bis-diethyl aminobenzophenone, or the like together with the photopolymerization initiator is preferred to improve the curing rate. There is no particular limitation on the amount to add the photopolymerization promoter as long as it has a positive effect. However, it is generally preferred to be 0.5 times to 2 times more than the mass of photopolymerization initiator.

There is no particular limitation on the electron-beam accelerator used for the electron beam irradiation. Example of the electron-beam accelerator include the electron beam irradiation device such as a Van der Graaf scanning method, a double scanning method, a curtain beam method, or the like.

There is no particular limitation on the ultraviolet irradiation device used for the UV irradiation. Examples of the ultraviolet irradiation device include a low-pressure mercury lamp, medium pressure mercury lamp, high-pressure mercury lamp, metal halide lamp, and the like.

The support may have a desired laminated structure of the various kinds of support mentioned above.

Methods for coating resin or the like on the raw paper or the like include coating, impregnating, or spraying a resin solution or suspension onto the raw paper.

To improve adhesion of the resin to be coated on the raw paper, it is preferred to give one or both surfaces of the raw paper an activation treatment, such as corona discharge treatment, flame treatment, glow discharge treatment or the like, or plasma treatment, prior to coating or laminating the resin.

A surface treatment such as corona discharge treatment may be given to the raw paper, the synthetic paper or synthetic resin sheet, or after disposing a coating layer or laminated layer thereon, or an undercoat may be applied to the surface, to improve the adhesion of the upper layer, for example, the toner image-receiving layer.

In addition, the surface of the thermoplastic resin layer used for the coated paper may, if necessary, be given a gloss finish, or a fine finish, matte finish or grainy finish as described in JP-A No. 55-26507, or a non-gloss finish may if necessary be given to the surface of the thermoplastic resin layer on the opposite side (back surface) to the surface on which the electroconducting layer is disposed. Further, activation such as corona discharge treatment or flame treatment can be applied to these surfaces after giving them a finish. Any known undercoating-treatment may also be given to these surfaces after activation.

These treatments may be carried out either alone, or in a desirable combination of two ore more treatments. The desirable combination includes subjecting the surface of the layer to activation after shaping or the like, providing under-coating after the activation, and the like.

The thickness of the support is preferably 25 μm to 300 μm, more preferably 50 μm to 260 μm, and still more preferably 75 μm to 220 μm. Supports having various rigidity may be used according to the purpose. It is preferred that the support used for electrophotographic image-receiving sheets of photographic image quality is close to the support used for color film photos.

From the viewpoint of fixing performance, it is preferred that the thermal conductivity of the support under the condition of 65% of relative humidity at 20° C. is, for example, 0.50 kcal/m·h·° C., or more. Here, thermal conductivity can be measured on a humidified transferring paper supported on JIS P 8111 by the process disclosed in JP-A No. 53-66279.

Various kinds of additives can be blended into the support. Examples of the additives include whiteners, conductive agents, fillers, titanium oxide, ultramarine blue, pigments such as carbon black, or the like.

Hydrophilic binders, alumina sol, semiconducting metal oxides such as tin oxide, and carbon black or other antistatic agents may be blended with the support, or coated on its surface or back surface, or both of the surfaces. Specifically, the support disclosed in JP-A No. 63-220246 may be used. It is preferred that this support can be resistant to the fixing temperature, and can satisfy requirements regarding whiteness degree, slipping properties, frictional properties, antistatic properties, depression after fixing, and the like.

Penetration Part of Support

In the support, it is appropriate that the thermoplastic resin in the intermediate layer, which will be described later, penetrates into a depth of 1% or more and less than 50%, and preferably 0.1% or more and less than 10%, and still more preferably 1% or more and less than 10%, of the thickness of the support measured from the surface of the support. By allowing the thermoplastic resin to penetrate into the depth, cracks in the image formed on the toner image-receiving layer can be prevented, and anticurl properties improve. Due to this coating, irregularity on a surface of the support can be alleviated by leveling of the intermediate layer coating solution.

This penetration part can be formed upon forming the intermediate layer, by preparing an intermediate layer coating solution to form the intermediate layer, and allowing it to penetrate in direction of the depth from the surface of the support. In this case also, the thermoplastic resin in the intermediate layer may have a concentration gradient, and may be present in a fixed uniform or non-uniform state, throughout the depth of the support.

According to a second aspect of the present invention, the thermoplastic resin in the intermediate layer penetrates into a depth of 0.01% or more and less than 1%, and preferably 0.1% or more and less than 1%, of the thickness of the support measured from the surface of the support.

If the thermoplastic resin penetrates into a depth of 1% or more of the thickness of the support, it is difficult to increase the thickness of the intermediate layer which is disposed on the surface of the support. As a result, the unevenness due to the surface of the support also affects the intermediate layer, the smoothness of a surface of the intermediate layer deteriorates, and the smoothness of a surface of the toner image-receiving layer is impaired. Moreover, pressure and heat fluctuations occur during the pressurizing and heating in the fixing step, a non-gloss part of several millimeters is produced, and brilliance declines.

On the other hand, if the thermoplastic resin penetrates into a depth of as small as less than 0.01%, and is only very near the surface of the raw paper, the adhesion between the raw paper and the toner image-receiving layer disposed thereon falls, and due to the pressurizing and heating in the fixing step, the toner image-receiving layer or the toner image thereon adheres to the fixing roller, separates away from the raw paper, and gives rise to offset.

To introduce the thermoplastic resin to the predetermined penetration depth, the intermediate layer coating solution may for example be coated on the surface of the support and then dried. The details of the method may be selected according to the depth to which the thermoplastic resin is to be introduced. The method may be determined according to the viscosity, surface tension, drying time and conditions of calendaring of the intermediate layer coating solution. By studying these various factors, the pigment can be made to penetrate to the predetermined depth in the depth direction of the support.

The viscosity of the intermediate layer coating solution is for example preferably 30 mPa·s or more, and more preferably 60 mPa·s or more. The upper limit of the viscosity is for example preferably 500 mPa·s, and more preferably 200 mPa·s. The thermoplastic resin can be made to penetrate to a deeper portion of the support by reducing the viscosity of the intermediate layer coating solution.

The surface tension of the intermediate layer coating solution is for example preferably 39 mN/m or less, and more preferably 35 mN/m or less. The lower limit of the surface tension is 20 mN/m in practice, and preferably, for example, 28 mN/m. The thermoplastic resin can be made to penetrate into a deeper portion of the support by reducing the surface tension of the intermediate layer coating solution.

After applying the intermediate layer coating solution, it is dried for preferably within 2 minutes, more preferably within one minute and more preferably within 30 seconds. If the drying is performed for a shorter time within the range of 2 minutes, the penetration depth can be reduced. The end point of drying should be such that the temperature of the coated surface is the same as that of the wet-bulb temperature of a dry atmosphere.

After applying the intermediate layer coating solution, and drying, it is preferred to carry out calendaring. The pressure of the calendaring may for example be 98 N/cm (10 kgf/cm) or more, and more preferably 294 N/cm (30 kgf/cm) or more. The upper limit is for example 3923 N/cm (400 kgf/cm), and preferably 981 N/cm (100 kgf/cm). The larger this pressure is, the deeper the penetration depth which can be achieved.

The temperature in the calendaring is preferably 120° C. or less, and more preferably 90° C. or less. Considering the problem of adhesion between the roller and the belt in the fixing step, the lower limit of the temperature in the calendaring is preferably of the order of approximately 40° C. The lower the calendaring temperature is, the deeper the penetration of the thermoplastic resin which can be achieved.

[Intermediate Layer]

In the present invention, the intermediate layer containing the thermoplastic resin is coated between the aforesaid support and the aforesaid toner image-receiving layer.

As described above, the intermediate layer is formed by preparing and applying the intermediate layer coating solution. Alternatively, the intermediate layer can be formed on the support relatively easily using the coating solution. Further, the thermoplastic resin can be made to penetrate in a direction of the thickness of the support.

Any type of thermoplastic resin may be used in the intermediate layer, as long as it can be contained in the intermediate layer coating solution. As the intermediate layer coating solution, a solution or dispersion of the thermoplastic resin is preferred.

The thermoplastic resin used in the intermediate layer may be any resin which can be used to prepare the intermediate layer coating solution, and it may be water-soluble or water-dispersible.

There is no particular restriction on the composition, bond structure, molecular structure, molecular weight, molecular weight distribution and form of the thermoplastic resin as long as the thermoplastic resin is water-soluble. The groups to give water-solubility are required for the thermoplastic resin to have water-solubility. Examples of the groups to give water-solubility include a hydroxyl group, a carboxylic acid group, an amino group, an amide group, an ether group, and the like.

Examples of water-soluble thermoplastic resins are given on page 26 of Research Disclosure vol.17,643, page 651 of Research Disclosure vol. 18,716, pp. 873-874 of Research Disclosure vol. 307,105, or pp. 71 to 75 of Japanese Patent Application Laid-Open No. 64-13546. Specific examples of the water-soluble thermoplastic resin include vinyl-pyrrolidone-vinyl acetate copolymer, styrene-vinyl-pyrrolidone copolymer, styrene-maleic anhydride copolymer, water-soluble polyester, water-soluble polyurethane, water-soluble nylon, water-soluble epoxy resin, and the like.

Examples of the water-dispersible thermoplastic resin include acrylate resin emulsion, polyvinyl acetate emulsion, SBR (styrene butadiene rubber) emulsion, NBR emulsion, polyester resin emulsion, polystyrene resin emulsion, urethane resin emulsion, and the like. Two or more of these can be used in combination. When the thermoplastic resin is gelatin, liming gelatin, acid-treated gelatin or so-called deliming gelatin which has a reduced calcium content, can be used according to the purpose. When the water-dispersible thermoplastic resin is gelatin, the gelatin can be selected from deliming gelatin such as lime gelatin, acid treatment gelatin, or the like, in which the content of calcium is reduced, according to object.

The following are examples of the thermoplastic resin.

(a) Thermoplastic Resins Containing an Ester Bond

Polyester resins obtained by condensation of a dicarboxylic acid component and an alcoholic component, polyacrylate resins or polymethacrylate resins such as polymethylmethacrylate, polybutylmethacrylate, polymethylacrylate, polybutyl acrylate, or the like; polycarbonate resins, polyvinyl acetate resins, styrene acrylate resins, styrene-methacrylate copolymer resins, vinyltoluene acrylate resins, or the like.

Specific examples of the dicarboxylic acid component include terephthalic acid, isophthalic acid, maleic acid, fumaric acid, phthalic acid, adipic acid, sebacic acid, azelaic acid, abietic acid, succinic acid, trimellitic acid, pyromellitic acid, and the like. These may be substituted by a sulfonic acid group or carboxyl group. Specific examples of the alcoholic component include ethylene glycol, diethylene glycol, propylene glycol, bisphenol A, diether derivative of bisphenol A (for example, ethylene oxide diadduct of bisphenol A, propylene oxide diadduct of bisphenol A) or bisphenol S, 2-ethyl cyclohexyldimethanol, neopentyl glycol, dicyclohexyldimethanol or glycerol. These may be substituted by hydroxyl groups.

Examples can also be found in JP-A No. 59-101395, No. 63-7971, No. 63-7972, No. 63-7973 and No. 60-294862. Commercial products that may be used include Byron 290, Byron 200, Byron 280, Byron 300, Byron 103, Byron GK-140 and Byron GK-130 from Toyobo Co., Ltd., Tufton NE-382, Tufton U-5, ATR-2009 and ATR-2010 from Kao Corporation, Eritel UE3500, UE3210 and XA-8153 from Unitika Ltd., and Polystar TP-220, R-188 from Nippon Synthetic Chemical Industry Co., Ltd.

(b) Polyolefin resins such as polyethylene resin and polypropylene resin, copolymer resins of olefins such as ethylene and propylene with other vinyl monomers, and acrylic resins, and the like.

(c) Polyurethane resin and the like.

(d) Polyamide resin, urea resin, and the like.

(e) Polysulfone resin, and the like.

(f) Polyvinyl chloride resin, polyvinylidene chloride resin, vinyl chloride-vinyl acetate copolymer resin, vinyl chloride-vinyl propionate copolymer resin, and the like.

(g) Polyol resins such as polyvinylbutyral, cellulosic resins such as ethyl cellulose resin and cellulose acetate resin, and the like.

(h) Polycaprolactone resin, styrene-maleic anhydride resin, polyacrylonitrile resin, polyether resin, epoxy resin, phenol resin, and the like.

Examples of SBR include 0561 or 0589 from JSR, and Nipol LX-426, LX-110, LX-2570X5 or SX-1105 from ZEON Corporation.

Examples of NBR include Nipol LX-1571, LX-1577, LX-513, SX-1503, or the like from ZEON Corporation.

Examples of styrene-acrylic resins include Nipol SX-1706 from ZEON Corporation, HE-1335, BH-997L from SEIKO CHEMICAL INDUSTRIES CO., LTD., DICfine K-96 from DAINIPPON INK AND CHEMICALS, INCORPORATED, and AE-318 or AE-373B from JSR, and the like.

These thermoplastic resins may be used either alone or in combination of two or more.

The thermoplastic resin in the intermediate layer is preferably a self-dispersing water-dispersible polyester resin emulsion which satisfies the following characteristics (1) to (4). The thermoplastic resin is a self-dispersing which does not use a surfactant, its hygroscopic properties are low even in a humid atmosphere, the drop in softening point due to moisture is small, and offset during fixing or sticking of sheets during storage can be prevented. Also, as it is aqueous, it excels in environmental friendliness and workability.

(1) The number average molecular weight (Mn) is preferably 5000 to 10000, and more preferably 5000 to 7000.

(2) The molecular weight distribution (weight-average molecular weight/number average molecular weight) is preferably ≦4, and more preferably, Mw/Mn≦3.

(3) The glass transition temperature (Tg) is preferably 40° C. to 100° C., and more preferably 50° C. to 80° C.

(4) The volume average particle diameter is preferably 20 nm to 200 nm, and more preferably 40 nm to 150 nm.

The blending proportion of the thermoplastic resin is normally 20% by mass or more, and preferably 30% by mass to 100% by mass, based on a mass of the intermediate layer.

The thermoplastic resin used for the intermediate layer preferably satisfies the physical properties disclosed in JP-B No. 05-127413, JP-A No. 08-194394, No. 08-334915, No. 08-334916, No. 09-171265 and No. 10-221877.

Unless they interfere with the function of the intermediate layer, the components mentioned below for the toner image-receiving layer can be blended with the intermediate layer, as desired.

[Toner Image-Receiving Layer]

In the present invention, a toner image-receiving layer is disposed on the intermediate layer, which is disposed on at least one surface of the support.

The amount of pigment in the toner image-receiving layer may be less than 40% by mass, preferably less than 25% by mass, more preferably less than 20% by mass, and still more preferably, none (0% by mass) based on the mass of the thermoplastic resin in the toner image-receiving layer. When there is a large proportion of pigment, blistering easily occurs and the toner image obtained is ruined.

The toner image-receiving layer may be formed by fusing the thermoplastic resin on the intermediate layer, however, preferably, it is coated on the intermediate layer using a toner image-receiving layer coating solution. Using a coating solution, the electrophotographic image-receiving sheet of the present invention can be manufactured relatively easily.

A backing layer is preferably disposed on the back surface of the support using the thermoplastic resin used for the toner image-receiving layer. In this case, anticurl properties of the electrophotographic image-receiving sheet largely improve.

The toner image-receiving layer has a function to receive toner which forms an image from a developing drum or intermediate transfer body by (static) electricity or pressure in a transfer step, and is fixed by heat, pressure, or the like, in a fixing step.

The thermoplastic resin used for the toner image-receiving layer has a glass transition temperature of 35° C. or more, and preferably 50° C. or more (however, it should be 100° C. or less). If the glass transition temperature is less than 35° C., when the toner image-receiving layer is applied, the brittleness of the toner image-receiving layer is inferior, unevenness of an image occurs on the surface of the toner image-receiving layer, and image properties deteriorate.

The glass transition temperature of the thermoplastic resin used for the toner image-receiving layer is required also to be higher than the glass transition temperature of the thermoplastic resin in the intermediate layer which is disposed underneath the toner image-receiving layer. If the glass transition temperature of the thermoplastic resin in the toner image-receiving layer is equal to, or lower than, that of the intermediate layer, the brilliance of the printed surface deteriorates.

The glass transition temperature of the thermoplastic resin in the toner image-receiving layer is preferably 10° C. higher or more, and more preferably 20° C. higher or more, than that of the intermediate layer.

As long as they do not interfere with the action of the toner image-receiving layer, the toner image-receiving layer can contain various additives in addition to the thermoplastic resin.

Thermoplastic Resin

The thermoplastic resin may be any resin having a glass transition temperature of 35° C. or more, and which deforms to receive the toner at the fixing temperature. The thermoplastic resin used for the toner image-receiving layer is preferably the same type of resin as that used as the binder of the toner. The resin of the toner is usually a polyester resin, styrene-acrylate copolymer, styrene-methacrylate copolymer, or the like. In this case, the thermoplastic resin used for the toner image-receiving layer of the present invention is preferably also a polyester resin, styrene-acrylate copolymer, styrene-methacrylate copolymer, or the like.

Examples of the thermoplastic resins include the followings:

(a) resins containing ester bonds, including, for example, polyester resins obtained by condensation of a dicarboxylic acid component with an alcohol component.

Specific examples of the dicarboxylic acid component include terephthalic acid, isophthalic acid, maleic acid, fumaric acid, phthalic acid, adipic acid, sebacic acid, azelaic acid, abietic acid, succinic acid, trimellitic acid, pyromellitic acid, and the like. The dicarboxylic acid components may be substituted with the sulfonic acid group and a carboxyl group or the like.

Specific examples of the alcohol component include ethylene glycol, diethylene glycol, propylene glycol, bisphenol A, diether derivative of bisphenol A such as ethyleneoxide diaddition product of bisphenol A, propylene oxide diaddition product of bisphenol A, or the like), bisphenol S, 2-ethyl cyclohexyl dimethanol, neopentyl glycol, cyclohexyldimethanol, glycerol, and the like. The alcohol component may be substituted with a hydroxyl group, or the like.

The examples of (a) resins containing ester bonds further include polyacrylic ester resins or polymethacrylic acid ester resins such as polymethylmethacrylate, polybutylmethacrylate, polymethyl acrylate, polybutylacrylate, or the like; polycarbonate resins, polyvinyl acetate resins, styrene acrylate resins, styrene-methacrylate ester copolymer resin, vinyltoluene acrylate resin, and the like.

Specific examples can be found in Japanese Patent Application Laid-Open (JP-A) Nos. 59-101395, 63-7971, 63-7972, 63-7973 and 60-294862.

Commercial products of the above-mentioned polyester resins include Bylon 290, Bylon 200, Bylon 280, Bylon 300, Bylon 103, Bylon GK-140 and Bylon GK-130 from Toyobo Co., Ltd; Tufton NE-382, Tufton U-5, ATR-2009 and ATR-2010 from Kao Corporation; Eritel UE3500, UE3210 and XA-8153 from Unitika, Ltd; Polyester TP-220, R-188 from The Nippon Synthetic Chemical Industry Co., Ltd., and the like.

(b) the polyolefin resin, including, for example, polyethylene resin and polypropylene resin, copolymer resins of olefins such as ethylene and propylene with other vinyl monomers, acrylic resins, and the like.

(c) polyurethane resins or the like

(d) polyamide resins, urea resins, or the like

(e) polysulfone resins or the like

(f) polyvinyl chloride resins, polyvinylidene chloride resins, copolymer resins of vinyl chloride-vinyl acetate, copolymer resins of vinyl chloride-vinyl propionate, or the like

(g) polyvinyl butyral, including, for example, a cellulose resin such as a polyol resin, ethyl cellulose resin, cellulose acetate resin, and the like

(h) polycaprolactone resin, including, for example, styrene-maleic anhydride resin, polyacrylonitrile resin, polyether resins, epoxy resins, phenol resins.

These thermoplastic resins can be used either alone or in combination of two or more.

It is preferred that the thermoplastic resin satisfies the physical properties disclosed in Japanese Patent Application Publication (JP-B) No. 05-127413, JP-A Nos. 08-194394, 08-334915, 08-334916, 09-171265, 10-221877, and the like.

The thermoplastic resin preferably satisfies the physical properties disclosed above when contained in the toner image-receiving layer. The thermoplastic resin preferably satisfies the physical properties alone. The thermoplastic resins above can be used in combination of two or more, each of which has different physical properties.

It is preferred that the thermoplastic resin has a larger molecular weight than that of the thermoplastic resin used for the toner. However, this molecular weight relation may not always be desirable depending on the thermodynamic properties of the thermoplastic resin used for the toner and the resin used for the toner image-receiving layer. For example, if the softening temperature of the resin used for the toner image-receiving layer is higher than that of the thermoplastic resin used for the toner, it is preferred that the molecular weights are identical, or that the molecular weight of the resin used for the toner image-receiving layer is smaller.

It is preferred that the thermoplastic resin used is a mixture of resins with identical compositions having different average molecular weights. The relation of molecular weights of thermoplastic resins used as toners is disclosed in JP-A No. 08-334915.

The molecular weight distribution of the thermoplastic resin is preferably wider than the molecular weight distribution of the thermoplastic resin used in the toner.

The thermoplastic resin is preferably suitable for a coating solution. The thermoplastic resin can be one of water-soluble and water-dispersible, as long as it can be used for a coating solution.

As long as being water-soluble, the thermoplastic resin may have any composition, bond structure, molecular structure, molecular weight, molecular weight distribution or formation.

In order to give the thermoplastic resin water-solubility, the thermoplastic resin is required to have a water-soluble group. Examples of the water-soluble group include a hydroxyl group, a carboxyl group, an amino group, an amide group, an ether group, and the like.

Examples of the water-soluble resins are given on page 26 of Research Disclosure No. 17,643, page 651 of Research Disclosure No. 18,716, pp. 873-874 of Research Disclosure Nos. 307,105 and pp. 71-75 of JP-A No. 64-13546.

Specific examples the water-soluble resins include a vinyl pyrrolidone-vinyl acetate copolymer, styrene-vinyl pyrrolidone copolymer, styrene-maleic anhydride copolymer, water-soluble polyester, water-soluble acryl, water-soluble polyurethane, water-soluble nylon, a water-soluble epoxy resin, and the like.

Examples of the water-dispersible resins include acrylic resin emulsion, polyvinyl acetate emulsion, SBR (styrene butadiene rubber) emulsion, polyester resin emulsion, polystyrene resin emulsion, urethane resin emulsion, and the like. These can be used in combination of two ore more. When the water-dispersible thermoplastic resin is gelatin, the gelatin can be selected from deliming gelatin such as lime gelatin, acid treatment gelatin, or the like, in which the content of calcium is reduced, according to object.

When the binder of the toners is a polyester resin, the polyester resin is preferably used in the toner image-receiving layer.

Examples of commercial products of the polyester resins include Bailon 290, Bailon 200, Bailon 280, Bailon 300, Bailon 103, Bailon GK-140 and Bailon GK-130 from Toyobo Co., Ltd; Tufton NE-382, Tufton U-5, ATR-2009 and ATR-2010 from Kao Corporation; Eritel UE3500, UE3210, XA-8153, KZA-7049 from Unitika Ltd.; Polyester TP-220 and R-188 from The Nippon Synthetic Chemical Industry Co., Ltd., and the like.

Examples of commercial products of the above-mentioned acrylic resins include SE-5437, SE-5102, SE-5377, SE-5649, SE-5466, SE-5482, HR-169, HR-124, HR-1127, HR-116, HR-113, HR-148, HR-131, HR470, HR-634, HR-606, HR-607, LR-1065, LR-574, LR-143, LR-396, LR-637, LR-162, LR-469, LR-216, BR-50, BR-52, BR-60, BR-64, BR-73, BR-75, BR-77, BR-79, BR-80, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, BR-117 from Mitsubishi Rayon Ltd.; Esrec P SE-0020, SE-0040, SE-0070, SE-0100, SE-1010, SE-1035 from Sekisui Chemical Co., Ltd.; Himer ST95 and ST120 from Sanyo Chemical Industries, Ltd.; and FM601 from Mitsui Chemicals, Inc.

Examples of commercial products of the polyester emulsion include Vilonal MD-1250, Md-1930, from Toyobo Co., Ltd; Plus coat Z-446, and Z-465 from GaO Chemical Industries; ES-611, ES-670 from DAINIPPON INK AND CHEMICALS, INCORPORATED; Pethregin A-160P, A-210, A-515GB, A-620 from TAKAMATSU OIL & FAT CO., LTD, and the like.

The film-forming temperature of the polymer is preferably room temperature or higher, from the viewpoint of pre-print storage, and preferably 100° C. or lower, from the viewpoint of fixing toners.

It is desirable to use a self-dispersing water-dispersible polyester resin emulsion satisfying the following properties (1) to (4) as the above-mentioned thermoplastic resin in the toner image-receiving layer. As this is a self-dispersing type which does not use a surfactant, its hygroscopicity is low even in a high humidity environment, its softening point is not much reduced by moisture, and offset produced during fixing, or sticking of sheets in storage, can be suppressed. Moreover, since it is aqueous, it is very environment-friendly and has excellent workability. As it uses a polyester resin which easily assumes a molecular structure with high cohesion energy, it has sufficient hardness in a storage environment, assumes a melting state of low elasticity (low viscosity) in the fixing step for electrophotography, and toner is embedded in the toner image-receiving layer so that a sufficiently high image quality is attained.

(1) The number average molecular weight (Mn) is preferably 5000 to 10000, and more preferably 5000 to 7000.

(2) The molecular weight distribution (Mw/Mn) (weight average molecular weight/number average molecular weight) is preferably 4 or less, and more preferably 3 or less.

(3) The glass transition temperature (Tg) is preferably 40° C. to 100° C., and more preferably 50° C. to 80° C.

(4) The volume average particle diameter is preferably 20 nm to 200 nm, and more preferably 40 nm to 150 nm.

The thermoplastic resin used in the toner image-receiving layer preferably has more values or amounts than the one used in the intermediate layer, with regard to the following properties (1) to (5).

(1) The softening point (Ts) of the thermoplastic resin contained in the toner image-receiving layer is, for example, 10° C. or more higher, and more preferably 20° C. or more higher than that of the thermoplastic resin contained in the intermediate layer. Adjusting the softening point enables controlling the brilliance. The softening point can be measure by, for example, a method determined in JIS K 7210.

(2) T1/2 (a softening point measured by 1/2 method) of the thermoplastic resin contained in the toner image-receiving layer is 10° C. or more higher, and preferably 20° C. or higher than that of the thermoplastic resin contained in the intermediate layer. Adjusting the T1/2 enables controlling the brilliance.

(3) Tfb (flow beginning temperature) of the thermoplastic resin contained in the toner image-receiving layer is 10° C. or more higher, and preferably 20° C. or higher than that of the thermoplastic resin contained in the intermediate layer. Adjusting the Tfb enables controlling the brilliance.

(4) Viscosity of the thermoplastic resin contained in the toner image-receiving layer at fixing temperature is three times or more, and preferably ten times or more than that of the thermoplastic resin contained in the intermediate layer. Adjusting the viscosity enables controlling the brilliance.

(5) Storage elasticity modulus (G′) of the thermoplastic resin contained in the toner image-receiving layer at fixing temperature is three times or more, and preferably ten times or more than that of the thermoplastic resin contained in the intermediate layer. Adjusting the storage elasticity modulus (G′) enables controlling the brilliance.

(6) Loss storage elasticity modulus (G″) of the thermoplastic resin contained in the toner image-receiving layer at fixing temperature is three times or more, and preferably ten times or more than that of the thermoplastic resin contained in the intermediate layer. Adjusting the loss storage elasticity modulus (G″) enables controlling the brilliance.

The number average molecular weight of the thermoplastic resin contained in the toner image-receiving layer is 1000 to 100000 smaller, and more preferably 1000 to 10000 smaller than that of the thermoplastic resin contained in the intermediate layer. Adjusting the number average molecular weight enables controlling the brilliance.

The molecular weight distribution of the thermoplastic resin contains in the toner image-receiving layer is 0.2 to 5 smaller than that of the thermoplastic resin contained in the intermediate layer. Adjusting the molecular weight distribution enables controlling the brilliance.

The toner image-receiving layer preferably satisfies the physical properties described in Japanese Patent No. 2788358, and JP-A Nos. 07-248637, 08-305067 and 10-239889.

A content of the thermoplastic resin in the toner image-receiving layer is preferably 10% by mass or more, and more preferably 30% by mass or more.

Various additives may be oriented to improve the thermodynamic properties of the toner image-receiving layer. Examples of the additives include plasticizers, fillers, crosslinking agents, charge control agents, emulsifiers, dispersants, and the like.

Plasticizers

The plasticizers known in the art may be used without any particular limitation. These plasticizers have the effect of adjusting the fluidity or softening of the toner image-receiving layer due to heat and/or pressure.

The plasticizer may be selected by referring to “Chemical Handbook,” (Chemical Institute of Japan, Maruzen), “Plasticizers—their Theory and Application,” (ed. Koichi Murai, Saiwai Shobo), “The Study of Plasticizers, Part 1” and “The Study of Plasticizers, Part 2” (Polymer Chemistry Association), or “Handbook of Rubber and Plastics Blending Agents” (ed. Rubber Digest Co.), or the like.

Some of the plasticizers are listed as high boiling point organic solvents, heat solvents, or the like. Specific examples can be found in JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, 62-174754, 62-245253, 61-209444, 61-200538, 62-8145, 62-9348, 62-30247, 62-136646 and 02-235694, or the like.

The specific examples include compounds of esters (for example, phthalic esters, phosphate esters, aliphatic acid esters, abiethyne acid ester, abietic acid ester, sebacic acid esters, azelinic ester, benzoates, butylates, epoxy aliphatic acid esters, glycolic acid esters, propionic acid esters, trimellitic acid esters, citrates, sulfonates, carboxylates, succinic acid esters, maleates, fumaric acid esters, phthalic acid esters, stearic acid esters, and the like), of amides (for example, aliphatic acid amides and sulfoamides), of ethers, of alcohols, of lactones, of polyethyleneoxy, and the like.

The plasticizers can be mixed into a resin.

The plasticizers may be polymers having relatively low molecular weight. In this case, it is preferred that the molecular weight of the plasticizer is lower than the molecular weight of the binder resin to be plasticized. Preferably plasticizers have a molecular weight of 15000 or less, or more preferably 5000 or less. When a polymer plasticizer is used as the plasticizer, the polymer of the polymer plasticizer is the same as that of the binder resin to be plasticized. For example, when the polyester resin is plasticized, polyester having low molecular weight is preferable. Further, oligomers may also be used as plasticizers. Apart from the compounds mentioned above, there are commercially products such as, for example, Adecasizer PN-170 and PN-1430 from Asahi Denka Co., Ltd.; PARAPLEX-G-25, G-30 and G-40 from C. P. Hall; and, rosin ester 8 L-JA, ester R-95, pentalin 4851, FK 115, 4820, 830, Ruizol 28-JA, Picolastic A75, Picotex LC and Cristalex 3085 from Rika Hercules, Inc, and the like.

The plasticizer can be used as desired to relax stress and distortion (physical distortions of elasticity and viscosity, and distortions of mass balance in molecules, binder main chains or pendant portions) which are produced when toners are embedded in the toner image-receiving layer.

The content of plasticizer in the toner image-receiving layer is preferably 0.001% by mass to 90% by mass, more preferably 0.1% by mass to 60% by mass, and still more preferably 1% by mass to 40% by mass.

The plasticizer may be used for the purposes of adjusting slip properties (improved transportability due to decrease in friction), improving offset at a fixing part (separation of toner or layers onto the fixing part), adjusting curl balance or adjusting charge (forming a toner electrostatic image).

Releasing Agent

The releasing agent can be blended to the toner image-receiving layer in order to prevent offset of the toner image-receiving layer. Various types of the releasing agent can be used as long as it is able to form a layer of the releasing agent on a surface of the toner image-receiving layer by being heated and melted so as to deposit and to remain on the surface of the toner image-receiving layer, and by being cooled and solidified so as to form a layer of the releasing agent, thereafter.

The releasing agent of the present invention is at least one releasing agent selected from silicone compounds, fluorine compounds, wax, and matting agents. Preferably, it is at least one releasing agent selected from silicone oil, polyethylene wax, silicone particles and polyethylene wax particles.

The releasing agent may for example be a compound mentioned in “Properties and Applications of Wax (Revised)” by Saiwai Publishing, or in the Silicone Handbook published by THE NIKKAN KOGYO SHIMBUN. Also, the silicone compounds, fluorine compounds and wax in the toners mentioned in Japanese Patent Application Publication (JP-B) No. 59-38581, Japanese Patent Application Publication JP-B) No. 04-32380, Japanese Patent (JP-B) No. 2838498, Japanese Patent (JP-B) No. 2949558, Japanese Patent Application Laid-Open (JP-A) No. 50-117433, No. 52-52640, No. 57-148755, No. 61-62056, No. 61-62057, No. 61-118760, and Japanese Patent Application Laid-Open (JP-A) No. 02-42451, No. 03-41465, No. 04-212175, No. 04-214570, No. 04-263267, No. 05-34966, No. 05-119514, No. 06-59502, No. 06-161150, No. 06-175396, No. 06-219040, No. 06-230600, No. 06-295093, No. 07-36210, No. 07-43940, No. 07-56387, No. 07-56390, No. 07-64335, No. 07-199681, No. 07-223362, No. 07-287413, No. 08-184992, No. 08-227180, No. 08-248671, No. 08-248799, No. 08-248801, No. 08-278663, No. 09-152739, No. 09-160278, No. 09-185181, No. 09-319139, No. 09-319143, No. 10-20549, No. 10-48889, No. 10-198069, No. 10-207116, No. 11-2917, No. 11-44969, No. 11-65156, No. 11-73049 and No. 11-194542 may be used. These compounds can also be used in combination of two or more.

Examples of the silicone compounds include non-modified silicone oils (specifically, dimethyl siloxane oil, methyl hydrogen silicone oil, phenyl methyl-silicone oil, or commercial products such as KF-96, KF-96L, KF-96H, KF-99, KF-50, KF-54, KF-56, KF-965, KF-968, KF-994, KF-995 and HIVAC F-4, F-5 from Shin-Etsu Chemical Co., Ltd.; SH200, SH203, SH490, SH510, SH550, SH710, SH704, SH705, SH7028A, SH7036, SM7060, SM7001, SM7706, SH7036, SH8710, SH1107 and SH8627 from Dow Corning Toray Silicone Co., Ltd.; and TSF400, TSF401, TSF404, TSF405, TSF431, TSF433, TSF434, TSF437, TSF450 series, TSF451 series, TSF456, TSF458 series, TSF483, TSF484, TSF4045, TSF4300, TSF4600, YF33 series, YF-3057, YF-3800, YF-3802, YF-3804, YF-3807, YF-3897, XF-3905, XS69-A1753, TEX100, TEX101, TEX102, TEX103, TEX104, TSW831, and the like from GE Toshiba Silicones), amino-modified silicone oils (for example, KF-857, KF-858, KF-859, KF-861, KF-864 and KF-880 from Shin-Etsu Chemical Co., Ltd., SF8417 and SM8709 from Dow Corning Toray Silicone Co., Ltd., and TSF4700, TSF4701, TSF4702, TSF4703, TSF4704, TSF4705, TSF4706, TEX150, TEX151 and TEX154 from GE Toshiba Silicones), carboxy-modified silicone oils (for example, BY16-880 from Dow Corning Toray Silicone Co., Ltd., TSF4770 and XF42-A9248 from GE Toshiba Silicones), carbinol-modified silicone oils (for example, XF42-B0970 from GE Toshiba Silicones), vinyl-modified silicone oils (for example, XF40-A1987 from GE Toshiba Silicones), epoxy-modified silicone oils (for example, SF8411 and SF8413 from Dow Corning Toray Silicone Co., Ltd.; TSF3965, TSF4730, TSF4732, XF42-A4439, XF42-A4438, XF42-A5041, XC96-A4462, XC96-A4463, XC96-A4464 and TEX170 from GE Toshiba Silicones), polyether-modified silicone oils (for example, KF-351 (A), KF-352 (A), KF-353 (A), KF-354 (A), KF-355 (A), KF-615(A), KF-618 and KF-945 (A) from Shin-Etsu Chemical Co., Ltd.; SH3746, SH3771, SF8421, SF8419, SH8400 and SF8410 from Dow Corning Toray Silicone Co., Ltd.; TSF4440, TSF4441, TSF4445, TSF4446, TSF4450, TSF4452, TSF4453 and TSF4460 from GE Toshiba Silicones), silanol-modified silicone oils, methacryl-modified silicone oil, mercapto-modified silicone oil, alcohol-modified silicone oil (for example, SF8427 and SF8428 from Dow Corning Toray Silicone Co., Ltd., TSF4750, TSF4751 and XF42-B0970 from GE Toshiba Silicones), alkyl-modified silicone oils (for example, SF8416 from Dow Corning Toray Silicone Co., Ltd., TSF410, TSF411, TSF4420, TSF4421, TSF4422, TSF4450, XF42-334, XF42-A3160 and XF42-A3161 from GE Toshiba Silicones), fluorine-modified silicone oils (for example, FS1265 from Dow Corning Toray Silicone Co., Ltd., and FQF501 from GE Toshiba Silicones), silicone rubbers and silicone fine particles (for example, SH851, SH745U, SH55UA, SE4705U, SH502 UA&B, SRX539U, SE6770 U-P, DY38-038, DY38-047, Trefil F-201, F-202, F-250, R-900, R-902A, E-500, E-600, E-601, E-506, BY29-119 from Dow Corning Toray Silicone Co., Ltd.; Tospal 105, Tospal 120, Tospal 130, Tospal 145, Tospal 240 and Tospal 3120 from GE Toshiba Silicones), silicone-modified resins (specifically, olefin resins, polyester resins, vinyl resins, polyamide resins, cellulosic resins, phenoxy resins, vinyl chloride-vinyl acetate resins, urethane resins, acrylic resins, styrene-acrylic resins, compounds in which copolymerization resins thereof are modified by silicone, and the like), and the like. Examples of the commercial products include Diaroma SP203V, SP712, SP2105 and SP3023 from Dainichiseika Color & Chemicals Mfg. Co., Ltd.; Modepa FS700, FS710, FS720, FS730 and FS770 from NOF CORPORATION; Simac US-270, US-350, US-352, US-380, US-413, US-450, Reseda GP-705, GS-30, GF-150 and GF-300 from TOAGOSEI CO., LTD.; SH997, SR2114, SH2104, SR2115, SR2202, DCI-2577, SR2317, SE4001U, SRX625B, SRX643, SRX439U, SRX488U, SH804, SH840, SR2107 and SR2115 from Dow Corning Toray Silicone Co., Ltd., YR3370, TSR1122, TSR102, TSR108, TSR116, TSR117, TSR125A, TSR127B, TSR144, TSR180, TSR187, YR47, YR3187, YR3224, YR3232, YR3270, YR3286, YR3340, YR3365, TEX152, TEX153, TEX171 and TEX172 from GE Toshiba Silicones), and reactive silicone compounds (specifically, addition reaction type, peroxide-curing type and ultraviolet radiation curing type, examples thereof include: TSR1500, TSR1510, TSR1511, TSR1515, TSR1520, YR3286, YR3340, PSA6574, TPR6500, TPR6501, TPR6600, TPR6702, TPR6604, TPR6700, TPR6701, TPR6705, TPR6707, TPR6708, TPR6710, TPR6712, TPR6721, TPR6722, UV9300, UV9315, UV9425, UV9430, XS56-A2775, XS56-A2982, XS56- A3075, XS56-A3969, XS56-A5730, XS56-A8012, XS56-B1794, SL6100, SM3000, SM3030, SM3200 and YSR3022 from GE Toshiba Silicones), and the like.

Examples of the fluorine compounds include fluorine oils (for example, Daifluoryl #1, Daifluoryl #3, Daifluoryl #10, Daifluoryl #20, Daifluoryl #50, Daifluoryl #100, Unidyne TG-440, TG-452, TG-490, TG-560, TG-561, TG-590, TG-652, TG-670U, TG-991, TG-999, TG-3010, TG-3020 and TG-3510 from Daikin Industries, Ltd.; MF-100, MF-110, MF-120, MF-130, MF-160 and MF-160E from Tohkem Products; S-111, S-112, S-113, S-121, S-131, S-132, S-141 and S-145 from Asahi Glass Co., Ltd.; and, FC-430 and FC-431 from DU PONT-MITSUI FLUOROCHEMICALS COMPANY, LTD.), fluoro rubbers (for example, LS63U from Dow Corning Toray Silicone Co., Ltd.), fluorine-modified resins (for example, Modepa F200, F220, F600, F220, F600, F2020, F3035 from Nippon Oils and Fats; Diaroma FF203 and FF204 from Dai Nichi Pure Chemicals; Saflon S-381, S-383, S-393, SC-101, SC-105, KH-40 and SA-100 from Asahi Glass Co., Ltd.; EF-351, EF-352, EF-801, EF-802, EF-601, TFE, TFEA, TFEMA and PDFOH from Tohkem Products; and THV-200P from Sumitomo 3M), fluorine sulfonic acid compound (for example, EF-101, EF-102, EF-103, EF-104, EF-105, EF-112, EF-121, EF-122A, EF-122B, EF-122C, EF-123A, EF-123B, EF-125M, EF-132, EF-135M, EF-305, FBSA, KFBS and LFBS from Tohkem Products), fluorosulfonic acid, and fluorine acid compounds or salts (specifically, anhydrous fluoric acid, dilute fluoric acid, fluoroboric acid, zinc fluoroborate, nickel fluoroborate, tin fluoroborate, lead fluoroborate, copper fluoroborate, fluorosilicic acid, fluorinated potassium titanate, perfluorocaprylic acid, ammonium perfluorooctanoate, and the like), inorganic fluorides (specifically, aluminum fluoride, potassium fluoride, fluorinated potassium zirconate, fluorinated zinc tetrahydrate, calcium fluoride, lithium fluoride, barium fluoride, tin fluoride, potassium fluoride, acid potassium fluoride, magnesium fluoride, fluorinated titanic acid, fluorinated zirconic acid, ammonium hexafluorinated phosphoric acid, potassium hexafluorinated phosphoric acid, and the like).

Examples of the wax include synthetic hydrocarbon, modified wax, hydrogenated wax, natural wax, and the like.

Examples of the synthetic hydrocarbon include polyethylene wax (for example, polyron A, 393, and H-481 from Chukyo Yushi Co., Ltd.; Sunwax E-310, E-330, E-250P, LEL-250, LEL-800, LEL-400P, from SANYO KASEI Co., Ltd.), polypropyrene wax (for example, biscoal 330-P, 550-P, 660-P from SANYO KASEI Co., Ltd.), Fischer toropush wax (for example, FT100, and FT-0070, from Nippon Seiro Co., Ltd.), an acid amide compound or an acid imide compound (specifically, stearic acid amide, anhydrous phthalic acid imide, or the like; for example, Cellusol 920, B-495, hymicron G-270, G-110, hydrine D-757 from Chukyo Yushi Co., Ltd.), and the like.

Examples of the modified wax include amine-modified polypropyrene (for example, QN-7700 from SANYO KASEI Co., Ltd.), acrylic acid-modified wax, fluorine-modified wax, olefin-modified wax, urethane wax (for example, NPS-6010, and HAD-5090 from Nippon Seiro Co., Ltd.), alcohol wax (for example, NPS-9210, NPS-9215, OX-1949, XO-020T from Nippon Seiro Co., Ltd.), and the like.

Examples of the hydrogenated wax include cured castor oil (for example, castor wax from Itoh Oil Chemicals Co., Ltd.), castor oil derivatives (for example, dehydrated castor oil DCO, DCO Z-1, DCO Z-3, castor oil aliphatic acid CO-FA, ricinoleic acid, dehydrated castor oil aliphatic acid DCO-FA, dehydrated castor oil aliphatic acid epoxy ester D-4 ester, castor oil urethane acrylate CA-10, CA-20, CA-30, castor oil derivative MINERASOL S-74, S-80, S-203, S-42X, S-321, special castor oil condensation aliphatic acid MINERASOL RC-2, RC-17, RC-55, RC-335, special castor oil condensation aliphatic acid ester MINERASOL LB-601, LB-603, LB-604, LB-702, LB-703, #11 and L-164 from Itoh Oil Chemicals Co., Ltd.), stearic acid (for example, 12-hydroxystearic acid from Itoh Oil Chemicals Co., Ltd.), lauric acid, myristic acid, palmitic acid, behenic acid, sebacic acid (for example, sebacic acid from Itoh Oil Chemicals Co., Ltd.), undecylenic acid (for example, undecylenic acid from Itoh Oil Chemicals Co., Ltd.), heptyl acids (heptyl acids from Itoh Oil Chemicals Co., Ltd.), maleic acid, high grade maleic oils (for example, HIMALEIN DC-15, LN-10, LN-00-15, DF-20 and SF-20 from Itoh Oil Chemicals Co., Ltd.), blown oils (for example, selbonol #10, #30, #60, R-40 and S-7 from Itoh Oil Chemicals Co., Ltd.), synthetic wax such as cyclopentadieneic oil (CP oil and CP oil-S from Itoh Oil Chemicals Co., Ltd., or the like), and the like.

The natural wax is preferably any wax selected from vegetable wax, animal wax, mineral wax, and petroleum wax.

Examples of the vegetable wax include carnauba wax (for example, EMUSTAR AR-0413 from Nippon Seiro Co., Ltd., and Cellusol 524 from Chukyo Yushi Co., Ltd.), castor oil (purified castor oil from Itoh Oil Chemicals Co., Ltd.), rapeseed oil, soybean oil, Japan tallow, cotton wax, rice wax, sugarcane wax, candellila wax, Japan wax, jojoba oil, and the like. Of these, carnauba wax having a melting point of 70° C. to 95° C. is particularly preferable from viewpoints of providing an electrophotographic image-receiving sheet which is excellent in anti-offset properties, adhesive resistance, paper transporting properties, gloss, is less likely to cause crack and splitting, and is capable of forming a high quality image.

Examples of the animal wax include bees wax, lanolin, spermaceti, whale oil, wool wax, and the like.

Examples of the mineral wax include montan wax, montan ester wax, ozokerite, ceresin, and the like, aliphatic acid esters (Sansosizer-DOA, AN-800, DINA, DIDA, DOZ, DOS, TOTM, TITM, E-PS, nE-PS, E-PO, E-4030, E-6000, E-2000H, E-9000H, TCP, C-1100, and the like, from New Japan Chemical Co., Ltd.), and the like. Of these, montan wax having a melting point of 70° C. to 95° C. is particularly preferable from viewpoints of providing an electrophotographic image-receiving sheet which is excellent in anti-offset properties, adhesive resistance, paper transporting properties, gloss, is less likely to cause crack and splitting, and is capable of forming a high quality image.

Examples of the petroleum wax include paraffin wax (for example, Paraffin wax 155, Paraffin wax 150, Paraffin wax 140, Paraffin wax 135, Paraffin wax 130, Paraffin wax 125, Paraffin wax 120, Paraffin wax 115, HNP-3, HNP-5, HNP-9, HNP-10, HNP-11, HNP-12, HNP-14G, SP-0160, SP-0145, SP-1040, SP-1035, SP-3040, SP-3035, NPS-8070, NPS-L -70, OX-2151, OX-2251, EMUSTAR-0384 and EMUSTAR-0136 from Nippon Oils and Fats Co., Ltd.; Cellosol 686, Cellosol 428, Cellosol 651-A, Cellosol A, H-803, B-460, E-172, E-866, K-133, hydrin D-337 and E-139 from Chukyo Yushi Co., Ltd.; 1250 paraffin, 125° FD, 130° paraffin, 1350 paraffin, 135° H, 140° paraffin, 140° N, 145° paraffin and paraffin wax M from Nippon Oil Corporation), or a microcrystalline wax (for example, Hi-Mic-2095, Hi-Mic-3090, Hi-Mic-1080, Hi-Mic-1070, Hi-Mic-2065, Hi-Mic-1045, Hi-Mic-2045, EMUSTAR-0001 and EMUSTAR-042X from Nippon Oils and Fats Co., Ltd; Cellosol 967, M, from Chukyo Yushi Co., Ltd.; 155 Microwax and 180 Microwax from Nippon Oil Corporation), and petrolatum (for example, OX-1749, OX-0450, OX-0650B, OX-0153, OX-261BN, OX-0851, OX-0550, OX-0750B, JP-1500, JP-056R and JP-011P from Nippon Oils and Fats Co., Ltd.), and the like.

A content of the natural wax in the toner image-receiving layer (a surface) is preferably 0.1 g/m² to 4 g/m², and more preferably 0.2 g/m² to 2 g/m². If the content is less than 0.1 g/m², the anti-offset properties and the adhesive resistance deteriorate. If the content is more than 4 g/m², the quality of an image may deteriorate because of the excessive amount of wax.

The melting point of the natural wax is preferably 70° C. to 95° C., and more preferably 75° C. to 90° C., from a viewpoint of anti-offset properties and paper transporting properties.

The matting agent can be selected from any known matting agent. Solid particles used as matting agents can be classified into inorganic particles and organic particles. Specifically, the inorganic matting agents may be oxides (for example, silicon dioxide, titanium oxide, magnesium oxide, aluminum oxide), alkaline earth metal salts (for example, barium sulfate, calcium carbonate, and magnesium sulfate), silver halides (for example, silver chloride, and silver bromide), glass, and the like.

Examples of the inorganic matting agents can be found, for example, in West German Patent No. 2529321, the U. K. Patent Nos. 760775, 1260772, and the U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Materials of the organic matting agent include starch, cellulose ester (for example, cellulose-acetate propionate), cellulose ether (for example, ethyl cellulose) and a synthetic resin. It is preferred that the synthetic resin is insoluble or difficult to become solved. Examples of insoluble or difficult to become solved in synthetic resins include poly(meth)acrylic acid esters (for example, polyalkyl(meth)acrylate, polyalkoxyalkyl(meth)acrylate, polyglycidyl(meth)acrylate), poly(meth) acrylamide, polyvinyl ester (for example, polyvinyl acetate), polyacrylonitrile, polyolefins (for example, polyethylene), polystyrene, benzoguanamine resin, formaldehyde condensation polymer, epoxy resin, polyamide, polycarbonate, phenolic resin, polyvinyl carbazole, polyvinylidene chloride, and the like.

Copolymers which combine the monomers used in the above polymers, may also be used.

In the case of the copolymers, a small amount of hydrophilic repeated units may be included. Examples of monomers which form a hydrophilic repeated unit include acrylic acid, methacrylic acid, α, β-unsaturated dicarboxylic acid, hydroxyalkyl(meth)acrylate, sulfoalkyl (meth)acrylate, and styrene sulfonic acid.

Examples of the organic matting agents can be found, for example, in the U.K. Patent No. 1055713, the U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821, and 57-14835.

Also, two or more types of solid particles may be used in combination. The average particle size of the solid particles may suitably be, for example, 1 μm to 100 μm, and is more preferably 4 μm to 30 μm. The usage amount of the solid particles may suitably be 0.01 g/m² to 0.5 g/m², and is more preferably 0.02 g/m² to 0.3 g/m².

The releasing agent added to the toner image-receiving layer of the present invention may also comprise different derivatives thereof, oxides, refined products and mixtures. These may also have reactive substituents.

The melting point (° C.) of this releasing agent is preferably 70° C. to 95° C., and more preferably 75° C. to 90° C. from the viewpoints of anti-offset properties and paper transport properties.

The releasing agent is also preferably a water-dispersible releasing agent, from the viewpoint of compatibility when a water-dispersible thermoplastic resin is used as the thermoplastic resin in the toner image-receiving layer.

The content of the releasing agent in the toner image-receiving layer is preferably 0.1% by mass to 10% by mass, more preferably 0.3% by mass to 8.0% by mass, and still more preferably 0.5% by mass to 5.0% by mass.

Colorant

Examples of colorants include fluorescent whitening agents, white pigments, colored pigments, dyes, and the like.

The fluorescent whitening agent has absorption in the near-ultraviolet region, and is a compound which emits fluorescence at 400 nm to 500 nm. The various fluorescent whitening agent known in the art may be used without any particular limitation.

Examples of the fluorescent whitening agent include the compounds described in “The Chemistry of Synthetic Dyes” Volume V, Chapter 8 edited by KVeenRataraman. Specific examples include stilbene compounds, coumarin compounds, biphenyl compounds, benzo-oxazoline compounds, naphthylamide compounds, pyrazoline compounds, carbostyryl compounds, and the like. Examples of these include white furfar-PSN, PHR, HCS, PCS, and B from Sumitomo Chemicals, UVITEX-OB from Ciba-Geigy, and the like.

Examples of the white pigments include the inorganic pigments described in the “fillers,” (for example, titanium oxide, calcium carbonate, and the like).

Examples of the colored pigments include various pigments and azo pigments described in JP-A No. 63-44653, (for example, azo lakes such as carmine 6B and red 2B, insoluble azo compounds such as monoazo yellow, disazo yellow, pyrazolo orange, Balkan orange, and condensed azo compounds such as chromophthal yellow and chromophthal red), polycyclic pigments (for example, phthalocyanines such as copper phthalocyanine blue and copper phthalocyanine green), thiooxidans such as thioxadine violet, isoindolinones such as isoindolinone yellow, surenes such as perylene, perinon, hulavanthoron and thioindigo, lake pigments (for example, malachite green, rhodamine B, rhodamine G and Victoria blue B), and inorganic pigment (for example, oxide, titanium dioxide, iron oxide red, sulfate; settling barium sulfate, carbonate; settling calcium carbonate, silicate; hydrous silicate, silicic anhydride, metal powder; aluminum powder, bronze powder, zinc powder, carbon black, chrome yellow, iron blue, or the like) and the like.

These may be used either alone, or in combination of two or more. Of these, titanium oxide is particularly preferred as the pigment.

There is no particular limitation on the form of the pigment. However, hollow particles are preferred from the viewpoint that they have excellent heat conductivity (low heat conductivity) during image fixing.

The various dyes known in the art may be used as the dye.

Examples of oil-soluble dyes include anthraquinone compounds, azo compounds, and the like.

Examples of water-insoluble dyes include vat dyes such as C.I.Vat violet 1, C.I.Vat violet 2, C.I.Vat violet 9, C.I.Vat violet 13, C.I.Vat violet 21, C.I.Vat blue 1, C.I.Vat blue 3, C.I.Vat blue 4, C.I.Vat blue 6, C.I.Vat blue 14, C.I.Vat blue 20 and C.I.Vat blue 35, or the like; disperse dyes such as C.I. disperse violet 1, C.I. disperse violet 4, C.I. disperse violet 10, C.I. disperse blue 3, C.I. disperse blue 7, C.I. disperse blue 58, or the like; and oil-soluble dyes such as C.I. solvent violet 13, C.I. solvent violet 14, C.I. solvent violet 21, C.I. solvent violet 27, C.I. solvent blue 11, C.I. solvent blue 12, C.I. solvent blue 25, C.I. solvent blue 55, or the like.

Colored couplers used in silver halide photography may also be preferably used.

A content (g/m²) of the colorant in the toner image-receiving layer (surface) is preferably 0.1 g/m² to 8 g/m², and more preferably 0.5 g/m² to 5 g/m².

If the content of colorant is less than 0.1 g/m², the light transmittance in the toner image-receiving layer becomes high. If the content of the colorant is more than 8 g/m², handling becomes more difficult due to crack, and adhesive resistance.

In the colorant, an amount of the pigment to be added is, based on the mass of the thermoplastic resin which forms the toner image-receiving layer, less than 40% by mass, more preferably less than 30% by mass, and still more preferably less than 20% by mass.

Filler

The filler may be an organic or inorganic filler. Reinforcers for binder resins, bulking agents and reinforcements known in the art may be used. This filler may be selected by referring to “Handbook of Rubber and Plastics Additives” (ed. Rubber Digest Co.), “Plastics Blending Agents—Basics and Applications” (New Edition) (Taisei Co.), “The Filler Handbook” (Taisei Co.), or the like.

As the filler, various inorganic fillers (or pigments) can be used. Examples of inorganic pigments include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate, mullite, and the like.

Silica and alumina are particularly preferred. These fillers may be used either alone or in combination of two or more. It is preferred that the filler has a small particle diameter. If the particle diameter is large, the surface of the toner image-receiving layer tends to become rough.

Examples of the silica include spherical silica and amorphous silica. The silica may be synthesized by the dry method, wet method or aerogel method. The surface of the hydrophobic silica particles may also be treated by trimethylsilyl groups or silicone. Colloidal silica is preferred. The average particle diameter of the silica is preferably 200 nm to 5000 nm.

The silica is preferably porous. The average particle diameter of the porous silica is preferably 4 nm to 120 nm, and more preferably 4 nm to 90 nm. The average pore volume per mass of porous silica is preferably 0.5 ml/g to 3 ml/g, for example.

The alumina includes anhydrous alumina and hydrated alumina. Examples of crystallized anhydrous aluminas which may be used are α, β, γ, δ, ξ, η, θ, κ, ρ, or χ. Hydrated alumina is preferred to anhydrous alumina. The hydrated alumina may be a monohydrate or trihydrate. Monohydrates include pseudo-boehmite, boehmite and diaspore. Trihydrates include gibbsite and bayerite. The average particle diameter of alumina is preferably 4 nm to 300 nm, and more preferably 4 nm to 200 nm. Porous alumina is preferred. The average pore size of porous alumina is preferably 50 nm to 500 nm. The average pore volume per mass of porous alumina is around 0.3 ml/g to 3 ml/g.

The alumina hydrate can be synthesized by the sol-gel method, in which ammonia is added to an aluminum salt solution to precipitate alumina, or by hydrolysis of an alkali aluminate. Anhydrous alumina can be obtained by dehydrating alumina hydrate by the action of heat.

It is preferred that the filler is 5 parts by mass to 2000 parts by mass, relative to the dry mass of the binder in the toner image-receiving layer where the filler is to be added.

Crosslinking Agent

A crosslinking agent can be added in order to adjust the storage stability or thermoplastic properties of the toner image-receiving layer. Examples of the crosslinking agent include compounds containing two or more reactive groups in the molecule, such as an epoxy group, an isocyanate group, an aldehyde group, an active halogen group, an active methylene group, an acetylene group and other reactive groups known in the art.

The crosslinking agent may also be a compound having two or more groups capable of forming bonds such as hydrogen bonds, ionic bonds, stereochemical bonds, or the like.

The crosslinking agent may be a compound known in the art such as a coupling agent for resin, curing agent, polymerizing agent, polymerization promoter, coagulant, film-forming agent, film-forming assistant, or the like. Examples of the coupling agents include chlorosilanes, vinylsilanes, epoxysilanes, aminosilanes, alkoxyaluminum chelates, titanate coupling agents, and the like. The examples further include other agents known in the art such as those mentioned in Handbook of Rubber and Plastics Additives (ed. Rubber Digest Co.).

Charge Control Agent

It is preferred that the toner image-receiving layer contains a charge control agent to adjust toner transfer and adhesion, and to prevent charge adhesion. The charge control agent may be any charge control agent known in the art. Examples of the charge control agent include surfactants such as a cationic surfactant, an anionic surfactant, an amphoteric surfactant, a nonionic surfactant, or the like; polymer electrolytes, electroconducting metal oxides, and the like. When the toner has a negative charge, it is preferred that the charge control agent blended with the toner image-receiving layer is, for example, cationic or nonionic.

Specific examples include cationic charge inhibitors such as quaternary ammonium salts, polyamine derivatives, cation-modified polymethylmethacrylate, cation-modified polystyrene, or the like; anionic charge inhibitors such as alkyl phosphates, anionic polymers, or the like; and nonionic charge inhibitors such as aliphatic ester, polyethylene oxide, or the like. The examples are not limited thereto, however.

Examples of the electroconducting metal oxides include ZnO, TiO₂, SnO₂, Al₂O₃, In₂O₃, SiO₂, MgO, BaO, MoO₃, and the like. These electroconducting metal oxides may be used alone, or may be used in the form of a complex oxide. Moreover, the metal oxide may contain other elements. For example, ZnO may contain Al, In, or the like, TiO₂ may contain Nb, Ta, or the like, and SnO₂ may contain (or, dope) Sb, Nb, halogen elements, or the like.

Other Additives

The materials used to obtain the toner image-receiving layer may also contain various additives to improve image stability when output, or to improve stability of the toner image-receiving layer itself. Examples of the additives used for these purposes include antioxidants, age resistors, degradation inhibitors, anti-ozone degradation inhibitors, ultraviolet ray absorbers, metal complexes, light stabilizers, preservatives, fungicide, and the like.

Examples of the antioxidants include chroman compounds, coumarane compounds, phenol compounds (for example, hindered phenols), hydroquinone derivatives, hindered amine derivatives, spiroindan compounds, and the like. The antioxidants can be found, for example, in JP-A No. 61-159644.

Examples of the age resistors can be found in “Handbook of Rubber and Plastics Additives,” Second Edition (1993, Rubber Digest Co.), pp. 76-121.

Examples of the ultraviolet ray absorbers include benzotriazo compounds (described in the U.S. Pat. No. 3,533,794), 4-thiazolidone compounds (described in the U.S. Pat. No. 3,352,681), benzophenone compounds (described in JP-A No. 46-2784), ultraviolet ray absorbing polymers (described in JP-A No. 62-260152).

Examples of the metal complexes can be found in the U.S. Pat. Nos. 4,241,155, 4,245,018, 4,254,195, and JP-A Nos. 61-88256, 62-174741, 63-199248, 01-75568, 01-74272.

The ultraviolet ray absorbers and the light stabilizers can be found in Handbook of Rubber and Plastics Additives, Second Edition (1993, Rubber Digest Co.), pp. 122-137 may also be used.

Photographic additives known in the art may also be added to the material used to obtain the toner image-receiving layer as described above. Examples of the photographic additives can be found in the Journal of Research Disclosure (hereinafter referred to as RD) No. 17643 (December 1978), No. 18716 (November 1979) and No. 307105 (November 1989). The relevant sections are shown.

| Type of additive | RD17643 | RD18716 | RD307105 |
|---|---|---|---|
| 1. Whitener | p 24 | p 648, right-hand | p 868 |
| | | column | |
| 2. Stabilizer | pp. 24-25 | p 649, right-hand | pp. 868-870 |
| | | column | |
| 3. Light absorbers | pp. 25-26 | p 649, right-hand | p 873 |
| (ultraviolet ray | | column | |
| absorbers) | | | |
| 4. Pigment image | p 25 | p 650, right-hand | p 872 |
| stabilizers | | column | |
| 5. Film-hardening | p 26 | p 651, left-hand | pp. 874-875 |
| agents | | column | |
| 6. Binders | p 26 | p 651, left-hand | pp. 873-874 |
| | | column | |
| 7. Plasticizers, lubricants | p 27 | p 650, right-hand | p 876 |
| | | column | |
| 8. Coating assistants | pp. 26-27 | p 650, right-hand | pp. 875-876 |
| (surfactants) | | column | |
| 9. Antistatic agents | p 27 | p 650, right-hand | pp. 867-877 |
| | | column | |
| 10. Matting agents | | | pp. 878-879 |

The toner image-receiving layer is formed by applying a coating solution which contains the polymer used for the toner image-receiving layer with a wire coater or the like to the intermediate layer, and drying the coating solution. The coating solution is prepared by dissolving or uniformly dispersing an additive such as a thermoplastic polymer, a plasticizer, or the like, into an organic solvent such as alcohol, ketone, or the like. The organic solvent used here may for example be methanol, isopropyl alcohol, methyl ethyl ketone, or the like. If the polymer used for the toner image-receiving layer is water-soluble, the toner image-receiving layer can be prepared by applying an aqueous solution of the polymer to the intermediate layer. Polymers which are not water-soluble may be applied to the intermediate layer in an aqueous dispersion.

The film-forming temperature of the polymer is preferably room temperature or higher, from the viewpoint of pre-print storage, and preferably 100° C. or lower, from the viewpoint of fixing toner particles.

The toner image-receiving layer is coated so that the amount of coating in mass after drying is preferably 1 g/m² to 20 g/m², and more preferably 4 g/m² to 15 g/m².

There is no particular limitation on the thickness of the toner image-receiving layer. However, it is preferably 1 μm to 30 μm, and more preferably 2 μm to 20 μm.

Physical Properties of Toner Image-Receiving Layer

The 180° separation strength of the toner image-receiving layer at the fixing temperature by the fixing member is preferably 0.1N/25 mm or less, and more preferably 0.041 N/25 mm or less. The 180° separation strength can be measured based on the method described in JIS K6887 using the surface material of the fixing member.

It is preferred that the toner image-receiving layer has a high degree of whiteness. This whiteness is measured by the method specified in JIS P 8123, and is preferably 85% or more. It is preferred that the spectral reflectance is 85% or more in the wavelength of 440 nm to 640 nm, and that the difference between the maximum spectral reflectance and minimum spectral reflectance in this wavelength is within 5%. Further, it is preferred that the spectral reflectance is 85% or more in the wavelength of 400 nm to 700 nm, and that the difference between the maximum spectral reflectance and the minimum spectral reflectance in the wavelength is within 5%.

Specifically, for the whiteness, the value of L* is preferably 80 or higher, more preferably 85 or higher, and still more preferably 90 or higher in a CIE 1976 (L*a*b*) color space. The color tint of the white color is preferably as neutral as possible. Regarding the color tint of the whiteness, the value of (a*)²+(b*)² is preferably 50 or less, more preferably 18 or less and still more preferably 5 or less in a (L*a*b*) space.

It is preferred that the toner image-receiving layer has a high surface gloss. The 45° gloss luster is preferably 60 or higher, more preferably 75 or higher, and still more preferably 90 or higher, over the whole range from white where there is no toner, to black where toner is densed at maximum.

However, the gloss luster is preferably 110 or less. If it is more than 110, the image has a metallic appearance which is undesirable.

Gloss luster may be measured by JIS Z 8741.

It is preferred that the toner image-receiving layer has a high smoothness. The arithmetic average roughness (Ra) is preferably 3 μm or less, more preferably 1 μm or less, and still more preferably 0.5 μm or less, over the whole range from white where there is no toner, to black where toner is densed at maximum.

Arithmetic average roughness may be measured by JIS B 0601, B 0651, and B 0652.

It is preferred that the toner image-receiving layer has one of the following physical properties, more preferred that it has several of the following physical properties, and most preferred that it has all of the following physical properties.

(1) Tg (glass transition temperature) of the toner image-receiving layer is 30° C. or higher, and Tg of the toner plus 20° C., or less.

(2) T1/2 (a softening point measured by 1/2 method) of the toner image-receiving layer is 60° C. to 200° C., and preferably 80° C. to 170° C. Herein, the softening point measured by the 1/2 method is measured using a specific apparatus. The softening point is taken to be the temperature which is 1/2 of the difference in piston strokes when flow starts and flow ends at various temperatures, when the temperature is increased at a predetermined uniform rate after a residual heat time of, for example, 300 seconds, at the initial set temperature (for example, 50° C.), while applying a predetermined extrusion load under specific conditions.

(3) Tfb (flow beginning temperature) of the toner image-receiving layer is 40° C. to 200° C., and Tfb of the toner image-receiving layer is preferably Tfb of the toner plus 50° C., or less.

(4) The temperature at which the viscosity of the toner image-receiving layer is 1×10⁵ cp is 40° C. or higher, lower than the corresponding temperature for the toner.

(5) At a fixing temperature of the toner image-receiving layer, the storage elasticity modulus (G′) is 1×10² Pa to 1×10⁵ Pa, and the loss elasticity modulus (G″) is 1×10² Pa to 1×10⁵ Pa.

(6) The loss tangent (G″/G′), which is the ratio of the loss elasticity modulus (G″) and the storage elasticity modulus (G′) at a fixing temperature of the toner image-receiving layer, is 0.01 to 10.

(7) The storage modulus (G′) at a fixing temperature of the toner image-receiving layer is minus 50 to plus 2500, relative to the storage elasticity modulus (G″) at a fixing temperature of the toner.

(8) The inclination angle on the toner image-receiving layer of the molten toner is 50° or less, and particularly preferably 40° or less. The toner image-receiving layer preferably satisfies the physical properties described in Japanese Patent No. 2788358, and JP-A Nos. 07-248637, 08-305067 and 10-239889.

Physical property (1) may be measured by a differential scanning calorimeter (DSC). Physical properties (2) and (3) may be measured, for example, by Flow Tester CFT-500 or 500D produced by Shimadzu Corporation. Physical properties (5) to (7) may be measured using a rotating rheometer (for example, Dynamic Analyser RADII produced by Rheometric Scientific F. E. Ltd.). Physical property (8) may be measured by the process disclosed in JP-A No. 08-334916 using a Contact Angle Measurement Apparatus, Kyowa Interface Science Co., LTD.

It is preferred that the surface electrical resistance of the toner image-receiving layer is 1×10⁶ Ω/cm² to 1×10¹⁵ Ω/cm² (under conditions of 25° C., 65% RH).

If the surface electrical resistance is less than 1×10⁶ Ω/cm², the toner amount transferred to the toner image-receiving layer is insufficient, and the density of the toner image obtained may be too low. On the other hand, if the surface electrical resistance is more than 1×10¹⁵ Ω/cm², more charge than necessary is produced during transfer. Therefore, toner is transferred insufficiently, image density is low and static electricity develops causing dust to adhere during handling of the electrophotographic image-receiving sheet, or misfeed, overfeed, discharge marks or toner transfer dropout may occur.

The surface electrical resistance of the surface on the opposite surface of the support to the toner image-receiving layer is preferably 5×10⁸ Ω/cm² to 3.2×10¹⁰ Ω/cm², and more preferably 1×10⁹ Ω/cm² to 1×10¹⁰ Ω/cm².

The surface electrical resistances are measured based on JIS K 6911. The sample is left with air-conditioning for 8 hours or more at a temperature of 20° C. and the humidity of 65%. Measurements are made using an R8340 produced by Advantest Ltd., under the same environmental conditions after giving an electric current for 1 minute at an applied voltage of 100V.

[Other Layers]

Other layers may include, for example, a surface protective layer, backing layer, contact improving layer, intermediate layer, undercoat, cushion layer, charge control (inhibiting) layer, reflecting layer, tint adjusting layer, storage ability improving layer, anti-adhering layer, anti-curl layer, smoothing layer, and the like. These layers may have a single-layer structure or may be formed of two or more layers.

Surface Protective Layer

A surface protective layer is disposed on the surface of the toner image-receiving layer to protect the surface of the electrophotographic image-receiving sheet, to improve storage properties, to improve ease of handling, to facilitate writing, to improve paper transporting properties within an equipment, to confer anti-offset properties, or the like. The surface protective layer may comprise one layer, or two or more layers. In the surface protective layer, various thermoplastic resins or thermosetting resins may be used as binders, and are preferably the same types of resins as those of the toner image-receiving layer. However, the thermodynamic properties and electrostatic properties are not necessarily identical to those of the toner image-receiving layer, and may be individually optimized.

The surface protective layer may comprise the various additives described above which can be used for the toner image-receiving layer. In particular, in addition to the releasing agents, the surface protective layer may include other additives, for example matting agents or the like. The matting agents may be any of these used in the related art.

From the viewpoint of fixing properties, it is preferred that the outermost surface layer of the electrophotographic image-receiving sheet (which refers to, for example, the surface protective layer, if disposed) has good compatibility with the toner. Specifically, it is preferred that the contact angle with molten toner is for 0° to 40°.

Backing Layer

It is preferred that, in the electrophotographic image-receiving sheet, a backing layer is disposed on the opposite surface on which the support is disposed toward the toner image-receiving layer in order to confer back surface output compatibility, and to improve back surface output image quality, curl balance and paper transporting properties within equipment.

There is no particular limitation on the color of the backing layer. However, if the electrophotographic image-receiving sheet of the invention is a double-sided output image-receiving sheet where an image is formed also on the back surface, it is preferred that the backing layer is also white. It is preferred that the whiteness and spectral reflectance are 85% or more, for both the top surface and the back surface.

To improve double-sided output compatibility, the backing layer may have an identical structure to that of the toner image-receiving layer. The backing layer may comprise the various additives described hereintofore. Of these additives, matting agents and charge control agents are particularly suitable. The backing layer may be a single layer, or may have a laminated structure comprising two or more layers.

Further, if releasing oil is used for the fixing roller, or the like, to prevent offset during fixing, the backing layer may have oil absorbing properties.

Contact Improving Layer

In the electrostatic image-receiving sheet, it is preferred to dispose a contact improving layer in order to improve the contact between the support and the toner image-receiving layer. The contact improving layer may contain the various additives described above. Of these, crosslinking agents are particularly preferred to be blended in the contact improving layer. Furthermore, to improve accepting properties to toner, it is preferred that the electrostatic image-receiving sheet further comprises a cushion layer between the contact improving layer and the toner image-receiving layer.

The thickness of the electrophotographic image-receiving sheet of the present invention can be suitably selected according to the purpose without particular limitation. The thickness is preferably 50 μm to 350 μm, and more preferably 10 μm to 280 μm.

<Toner>

In the electrostatic image-receiving sheet, the toner image-receiving layer receives toners during printing or copying.

The toner contains at least a binder resin and a colorant, but may contain releasing agents and other components, if necessary.

Binder Resin for Toner

Examples of the binder resin include vinyl monopolymer of: styrenes such as styrene, parachlorostyrene, or the like; vinyl esters such as vinyl naphthalene, vinyl chloride, vinyl bromide, vinyl fluoride, vinyl acetate, vinyl propionate, vinyl benzoate, vinyl butyrate, or the like; methylene aliphatic carboxylates such as methyl acrylate, ethyl acrylate, n-butyl acrylate, isobutyl acrylate, dodecyl acrylate, n-octyl acrylate, 2-chloroethyl acrylate, phenyl acrylate, α-methyl chloroacrylate, methyl methacrylate, ethyl methacrylate, butyl acrylate, or the like; vinyl nitriles such as acryloniotrile, methacrylonitrile, acrylamide, or the like; vinyl ethers such as vinyl methyl ether, vinyl ethyl ether, vinyl isobutyl ether, or the like; N-vinyl compounds such as N-vinyl pyrrole, N-vinylcarbazole, N-vinyl indole, N-vinyl pyrrolidone, or the like; and vinyl carboxylic acids such as methacrylic acid, acrylic acid, cinnamic acid, or the like. These vinyl monomers may be used either alone, or copolymers thereof may be used. Of these resins, it is preferable to use a resin of the same type as the resin used for the toner image-receiving layer.

Colorants for the Toner

The colorants generally used in the art can be used without limitation. Examples of the colorants include carbon black, chrome yellow, Hansa yellow, benzidine yellow, thuren yellow, quinoline yellow, permanent orange GTR, pyrazolone orange, Balkan orange, watch young red, permanent red, brilliant carmin 3B, brilliant carmin 6B, dippon oil red, pyrazolone red, lithol red, rhodamine B lake, lake red C, rose bengal, aniline blue, ultramarine blue, chalco oil blue, methylene blue chloride, phthalocyanine blue, phthalocyanine green, malachite green oxalate, or the like. Various dyes may also be added such as acridine, xanthene, azo, benzoquinone, azine, anthraquinone, thioindigo, dioxadine, thiadine, azomethine, indigo, thioindigo, phthalocyanine, aniline black, polymethine, triphenylmethane, diphenylmethane, thiazine, thiazole, xanthene, or the like. These colorants may be used either alone, or in combination of a plurality of colorants.

It is preferred that the content of the colorant is 2% by mass to 8% by mass. If the content of colorant is more than 2% by mass, the coloration does not become weaker. If it is 8% by mass or less, transparency does not deteriorate.

Releasing Agent for the Toner

The releasing agent may be in principle any of the wax known in the art. Polar wax containing nitrogen such as highly crystalline polyethylene wax having relatively low molecular weight, Fischertropsch wax, amide wax, urethane wax, and the like are particularly effective. For polyethylene wax, it is particularly effective if the molecular weight is 1000 or less, and is effective more preferably if the molecular weight is 300 to 1000.

Compounds containing urethane bonds have a solid state due to the strength of the cohesive force of the polar groups even if the molecular weight is low, and as the melting point can be set high in view of the molecular weight, they are suitable. The preferred molecular weight is 300 to 1000. The initial materials may be selected from various combinations such as a diisocyane acid compound with a mono-alcohol, a monoisocyanic acid with a mono-alcohol, dialcohol with mono-isocyanic acid, tri-alcohol with a monoisocyanic acid, and a triisocyanic acid compound with mono-alcohol. To prevent the increase of molecular weight, it is preferred to use a combination of compounds with polyfunctional groups and monofunctional groups, and it is important to use equivalent amounts of functional groups.

Among the initial materials, examples of the monoisocyanic acid compounds include dodecyl isocyanate, phenyl isocyanate and derivatives thereof, naphthyl isocyanate, hexyl isocyanate, benzyl isocyanate, butyl isocyanate, allyl isocyanate, and the like.

Examples of the diisocyanic acid compounds include toluene diisocyanate, 4,4′-diphenylmethane diisocyanate, toluene diisocyanate, 1,3-phenylene diisocyanate, hexamethylene diisocyanate, 4-methyl-m-phenylene diisocyanate, isophorone diisocyanate, and the like.

Examples of the mono-alcohol include ordinary alcohols such as methanol, ethanol, propanol, butanol, pentanol, hexanol, heptanol, and the like.

Among the initial materials, examples of the di-alcohols include numerous glycols such as ethylene glycol, diethylene glycol, triethylene glycol, trimethylene glycol, or the like; and examples of the tri-alcohols include trimethylol propane, triethylol propane, trimethanolethane, and the like. The present invention is not necessarily limited these examples, however.

These urethane compounds may be mixed with the resin or the colorant during kneading, as an ordinary releasing agent, and used also as a kneaded-crushed toner. Further, in a case of using an emulsion polymerization cohesion scorification toner, the urethane compounds may be dispersed in water together with an ionic surfactant, polymer acid or polymer electrolyte such as a polymer base, heated above the melting point, and converted to fine particles by applying an intense shear in a homogenizer or pressure discharge dispersion machine to manufacture a releasing agent particle dispersion of 1 μm or less, which can be used together with a resin particle dispersion, colorant dispersion, or the like.

Toner, Other Components

The toner may also contain other components such as internal additives, charge control agents, inorganic particles, or the like. Examples of the internal additives include metals such as ferrite, magnetite, reduced iron, cobalt, nickel, manganese, or the like; alloys or magnets such as compounds containing these metals.

Examples of the charge control agents include dyes such as quaternary ammonium salt, migrosine compounds, dyes made from complexes of aluminum, iron and chromium, or triphenylmethane pigments. The charge control agent can be selected from the ordinary charge control agent. Materials which are difficult to become solved in water are preferred from the viewpoint of controlling ionic strength which affects cohesion and stability during melting, and the viewpoint of less waste water pollution.

The inorganic fine particles may be any of the external additives for toner surfaces generally used, such as silica, alumina, titania, calcium carbonate, magnesium carbonate, tricalcium phosphate, or the like. It is preferred to disperse these with an ionic surfactant, polymer acid or polymer base.

Surfactants can also be used for emulsion polymerization, seed polymerization, pigment dispersion, resin particle dispersion, releasing agent dispersion, cohesion or stabilization thereof. Examples of the surfactants include anionic surfactants such as sulfuric acid ester salts, sulfonic acid salts, phosphoric acid esters, soaps, or the like; cationic surfactants such as amine salts, quaternary ammonium salts, or the like. It is also effective to use non-ionic surfactants such as polyethylene glycols, alkylphenol ethylene oxide adducts, polybasic alcohols, or the like. These may generally be dispersed by a rotary shear homogenizer or a ball mill, sand mill, dyno mill, or the like, all of which contain the media.

The toner may also contain an external additive, if necessary. Examples of the external additive include inorganic powder, organic particles, and the like. Examples of the inorganic particles include SiO₂, TiO₂, Al₂O₃, CuO, ZnO, SnO₂, Fe₂O₃, MgO, BaO, CaO, K₂O, Na₂O, ZrO₂, CaO.SiO₂, K₂O (TiO₂), Al₂O₃.2SiO₂, CaCO₃, MgCO₃, BaSO₄, MgSO₄, and the like. Examples of the organic particles include aliphatic acids, derivatives thereof, and the like, powdered metal salts thereof, and resin powders such as fluorine resin, polyethylene resin, acrylic resin, or the like. The average particle diameter of the powder may be, for example, 0.01 μm to 5 μm, and is more preferably 0.1 μm to 2 μm.

There is no particular limitation on the process of manufacturing the toner, but it is preferably manufactured by a process comprising the steps of (i) forming cohesive particles in a dispersion of resin particles to manufacture a cohesive particle dispersion, (ii) adding a fine particle dispersion to the cohesive particle dispersion so that the fine particles adhere to the cohesive particles, thus forming adhesion particles, and (iii) heating the adhesion particles which melt to form toner particles.

Toner Physical Properties

It is preferred that the volume average particle diameter of the toner is from 0.5 μm to 10 μm.

If the volume average particle diameter of the toner is too small, it may have an adverse effect on handling of the toner (supplementation, cleaning properties, fluidability, or the like), and productivity of the toner may deteriorate. On the other hand, if the volume average particle damage is too large, it may have an adverse effect on image quality and resolution, both of which lead to granulariness and transferring properties.

It is preferred that the toner satisfies the toner volume average particle diameter range, and that the volume average particle distribution index (GSDv) is 1.3 or less.

It is preferred that the ratio (GSDv/GSDn) of the volume average polymer distribution index (GSDv) and the number average particle distribution index (GSDn) is 0.95 or more.

It is preferred that the toner satisfies the volume average particle diameter range, and that the average value of the formation coefficient expressed by the following equation is 1.00 to 1.50;

Formation coefficient=(π×L²)/(4×S)

(where, “L” is the maximum length of the toner particles, and “S” is the projection surface area of a toner particle).

If the toner satisfies the above conditions, it has a desirable effect on image quality, and in particular, on granulariness and resolution. Also, there is less risk of dropout and blur accompanying with toner transferring, and less risk of adverse effect on handling properties, even if the average particle diameter is not small.

The storage elasticity modulus G′ (measured at an angular frequency of 10 rad/sec) of the toner itself at 150° C. is 10 Pa to 200 Pa, which is suitable for improving image quality and preventing offset in a fixing step.

<Process for Image Formation>

A process for image formation according to the present invention comprises, in a first aspect, the step of forming a toner image on the electrophotographic image-receiving sheet of the present invention, the step of heating and pressurizing a surface of the electrophotographic image-receiving sheet on which the toner image is formed with a fixing bet and a roller, and the step of cooling the surface, so as to separate the surface from the fixing belt.

An process for image formation comprises, in a second aspect, the step of forming a toner image on the electrophotographic image-receiving sheet of the present invention, the step of fixing the toner image with a heat roller; the step of heating and pressurizing a surface of the electrophotographic image-receiving sheet on which the toner image is formed with a fixing belt and a roller; and the step of cooling the surface, so as to separate the surface from the fixing belt.

The process for transferring of the present invention utilizes ordinary processes employed in a process for electrophotography. Specifically, one of the ordinary processes may be directly transferring a toner image formed on a development roller onto an electrophotographic image-receiving sheet. The process may be the intermediate transfer belt process, where a toner image is first transferred onto an intermediate transfer belt, and is then transferred onto an electrophotographic image-receiving sheet. From the viewpoints of surrounding stability and higher quality image, the intermediate transfer belt process is more preferable.

Regarding the electrophotographic image-receiving sheet of the present invention, the toner transferred to the image-receiving sheet is fixed on the electrophotographic image-receiving sheet using an apparatus for electrophotography having a fixing belt. The belt fixing method may for example be the oilless apparatus for electrophotography as described in JP-A No. 11-352819, or the method where a secondary transfer and fixing are realized simultaneously as described in JP-A Nos. 11-231671 and 05-341666.

An apparatus for electrophotography having a fixing belt according to the present invention may be an apparatus for electrophotography including for example at least a heating and pressurizing part which can melt and pressurize the toner, a fixing belt which can transport the electrophotographic image-receiving sheet with toner adhering while in contact with the toner image-receiving layer, and a cooling part which can cool the heated image-receiving sheet while it is still adhering to the fixing belt.

By using the electrophotographic image-receiving sheet having the toner image-receiving layer in the apparatus for electrophotography which includes the fixing belt, toner adhering to the toner image-receiving layer is fixed in fine detail without spreading onto the electrophotographic image-receiving sheet, and the molten toner is cooled and solidified, while adhering closely to the fixing belt. In this way, the toner is received onto the electrophotographic image-receiving sheet with completely embedded in the toner image-receiving layer. Therefore, there are no image discrepancies, and a glossy and smooth toner image is obtained.

The electrophotographic image-receiving sheet is particularly suitable for forming an image by the oilless belt fixing method, and it permits a large improvement of offset. However, other methods for forming an image may also likewise be used.

For example, by using the electrophotographic image-receiving sheet, a full-color image can easily be formed while improving image quality and preventing cracks. A full-color image can be formed using an apparatus for electrophotography capable of forming full-color images. An ordinary apparatus for electrophotography includes an image-receiving paper transporting part, latent image-forming part, and developing part disposed in the vicinity of the latent image-forming part.

To improve image quality, adhesive transfer or heat assistance transfer may be used instead of the electrostatic transfer or bias roller transfer, or in combination therewith. Specific details of these methods are given for example in JP-A Nos. 63-113576 and 05-341666. It is particularly preferred to use an intermediate transfer belt in the heat assistance transfer method. Also, it is preferred to provide a cooling device for the intermediate belt after toner transfer or in the latter half of transfer to the electrophotographic image-receiving sheet. Due to this cooling device, the toner (toner image) is cooled to the softening point of the binder resin or lower, or the glass transition temperature of the toner plus 10° C. or less, hence the image is transferred to the electrophotographic image-receiving sheet efficiently and can be separated away from the intermediate transfer belt.

The fixing method may be carried out by a heating and pressurizing roller, or belt fixing using a belt, but from the viewpoint of image quality such as gloss and smoothness, belt fixing is preferred. Belt fixing methods known in the art include for example an oil-less belt fixing described in JP-A No. 11-352819, and the method where secondary transfer and fixing are realized simultaneously described in JP-A Nos. 11-231671 and 05-341666. Further, a first fixing may also be performed by a heat roller before the heating and pressurizing by the fixing belt and fixing roller.

The surface of the fixing belt may receive a surface treatment of a silicone compound, fluorine compound or a combination thereof to prevent peeling of the toner and prevent offset of the toners. Also, it is preferred to provide a belt cooling device in the latter half of fixing, which improves the separation of the electrophotographic image-receiving sheet. The cooling temperature is preferably the softening point or lower, or the glass transition temperature plus 10° C. or lower, of a binder resin used for the toner and/or the polymer in the toner image-receiving layer of the electrophotographic image-receiving sheet. On the other hand, in the first stage of fixing, the temperature of the toner image-receiving layer or toner on the electrophotographic image-receiving sheet must be raised to the temperature at which they become sufficiently softened. Specifically, it is preferred in practice that the cooling temperature is 30° C. to 70° C., and that it is 100° C. to 180° C. at the initial stage of fixing.

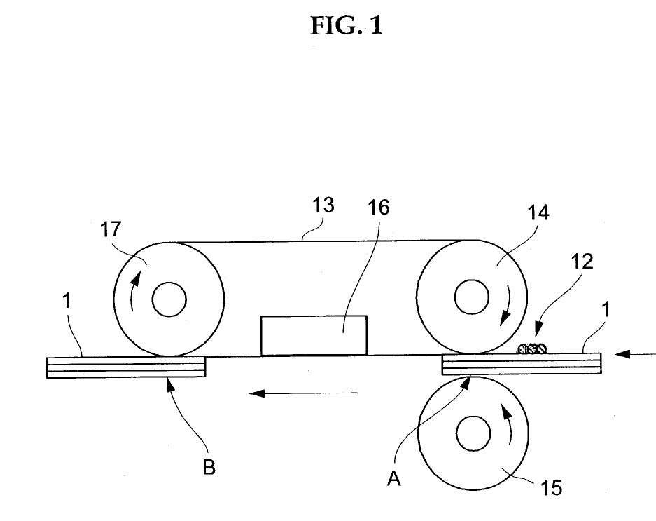

Hereafter, an example of the apparatus for image formation having a typical fixing belt will be described referring into FIG. 1. It should however be understood that the present invention is not limited to the aspect shown in FIG. 1.

First, toners (12) are transferred onto an electrophotographic image-receiving sheet (1) by an apparatus for image formation, (which is not shown in FIG. 1). The electrophotographic image-receiving sheet (1) to which the toners (12) adhere is transported to a point A by a transporting equipment (which is not shown in FIG. 1), and is transported between a heat roller (14) and pressurizing roller (15), and is thereby heated and pressurized to a temperature (fixing temperature) and to pressure at which a toner image-receiving layer of the electrophotographic image-receiving sheet (1), or the toner (12), are sufficiently softened.

Herein, the fixing temperature means the temperature of the toner image-receiving layer surface measured at the position between the heat roller (14) and the pressurizing roller (15), which is nip part at the point A, and is for example 80° C. to 190° C., and more preferably 100° C. to 170° C. The pressure means the pressure of the toner image-receiving layer surface measured at a portion between the heat roller (14) and the pressurizing roller (15), which is the nip part, and is for example 1 kg/cm² to 10 kg/cm², and more preferably 2 kg/cm² to 7 kg/cm². While the electrophotographic image-receiving sheet (1) is thus heated and pressurized, and is transported to the cooling device (16) by a fixing belt (13), a releasing agent (not shown), which was present in a discrete state inside the toner image-receiving layer, become melted by sufficient heating and moves up to a surface of the toner image-receiving layer. The releasing agent that moved up to the surface of the toner image-receiving layer forms a layer (a film) of the releasing agent. Thereafter, the electrophotographic image-receiving sheet (1) is transported to the cooling device (16) with the fixing belt (13), and is cooled for example to the softening point of the binder resin or lower, or the glass transition temperature plus 10° C. or lower of the binder resin used in the polymer and/or toner on the toner image-receiving layer, which is preferably 20° C. to 80° C., and more preferably room temperature (25° C.). In this way, the layer (film) of releasing agent disposed on the surface of the toner image-receiving layer is cooled and solidified, and the layer of the releasing agent is disposed due to change in the releasing agent, in the toner image-receiving layer.

The cooled electrophotographic image-receiving sheet (1) is then transported to the point B by the fixing belt (13), and the fixing belt (13) is rotated by a tension roller (17). Therefore, at the point B, the electrophotographic image-receiving sheet (1) and fixing belt (13) become separated. It is preferred to have a smaller diameter of the tension roller, so that the electrophotographic image-receiving sheet voluntarily separates from the belt with its own rigidity (strength).

The fixing belt is preferably an endless belt comprising polyimide, electroforming nickel and aluminum as a base material. A thin layer formed of at least one selected from silicone rubber, fluorine rubber, silicone resin, and fluorine resin is disposed on a surface of the fixing belt. Of these, it is preferred to dispose a layer of fluorocarbon siloxane rubber on the surface of the fixing belt, or to dispose a layer of silicone rubber on the surface of the fixing belt, and then to dispose a layer of fluorocarbon siloxane rubber on the surface of the layer of silicone rubber.

It is preferred that the fluorocarbon siloxane rubber has a perfluoroalkyl ether group and/or a perfluoroalkyl group in a main chain thereof.

Examples of the fluorocarbon siloxane rubber include: (A) a fluorocarbon polymer having a fluorocarbon siloxane expressed by the following Formula 1 as its main component, and containing aliphatic unsaturated groups, (B) an organopolysiloxane and/or fluorocarbon siloxane containing two or more ≡SiH groups in one molecule, and 1 to 4 times more the molar amount of ≡SiH groups than the amount of aliphatic unsaturated groups in the fluorocarbon siloxane rubber, (C) a filler, and (D) an effective amount of catalyst.

The fluorocarbon polymer having (A) as a component comprises a fluorocarbon siloxane containing a repeated unit expressed by the following Formula 1 as its main component, and contains aliphatic unsaturated groups.

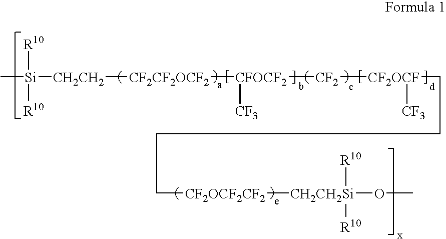

Herein, in the Formula 1, R¹⁰ is a non-substituted or substituted monofunctional hydrocarbon group preferably containing 1 to 8 carbon atoms, preferably an alkyl group containing 1 to 8 carbon atoms or an alkenyl group containing 2 to 3 carbon atoms, and particularly preferably a methyl group. “a” and “e” are respectively an integer of 0 or 1; “b” and “d” are respectively an integer of 1 to 4, and “c” is an integer of 0 to 8. “x” is an integer of 1 or more, and preferably 10 to 30.

An example of this component (A) include a substance expressed by the following Formula 2:

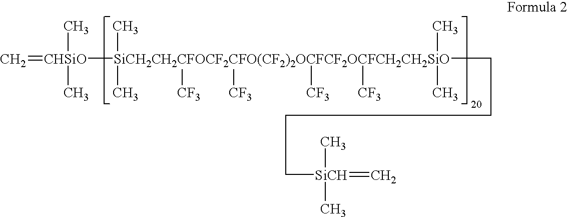

In Component (B), one example of the organopolysiloxane comprising ≡SiH groups is an organohydrogenpolysiloxane having at least two hydrogen atoms bonded to silicon atoms in the molecule.

In the fluorocarbon siloxane rubber composition, when the organocarbon polymer of Component (A) comprises an aliphatic unsaturated group, the organohydrogenpolysiloxane may be used as a curing agent. Namely, in this case, the cured product is formed by an addition reaction between aliphatic unsaturated groups in the fluorocarbon siloxane, and hydrogen atoms bonded to silicon atoms in the organohydrogenpolysiloxane.

Examples of these organohydrogenpolysiloxanes include the various organohydrogenpolysiloxanes used in an addition-curing silicone rubber composition.

It is generally preferred that the organohydrogenpolysiloxane is blended in such a proportion that the number of “≡SiH groups” therein is at least one, and particularly 1 to 5, relative to one aliphatic unsaturated hydrocarbon group in the fluorocarbon siloxane of Component (A).

It is preferred that in the fluorocarbon containing ≡SiH groups, one unit of the Formula 1 or R¹⁰ in the Formula 1 is a dialkylhydrogensiloxane group, the terminal group is a ≡SiH group such as a dialkylhydrogensiloxane group, a silyl group, or the like. An example of the fluorocarbon includes those expressed by the following Formula 3.

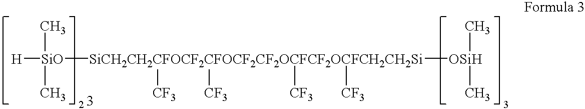

The filler, which is Component (C), may be various fillers used in ordinary silicone rubber compositions. Examples are reinforcing fillers such as mist silica, precipitated silica, carbon powder, titanium dioxide, aluminum oxide, quartz powder, talc, sericite, bentonite, or the like; fiber fillers such as asbestos, glass fiber, organic fibers or the like.

Examples of the catalyst which contains Component (D), include those any known as an addition reaction catalyst in the art. Specific examples of the catalyst include chloroplatinic acid, alcohol-modified chloroplatinic acid, complexes of chloroplatinic acid and olefins, platinum black or palladium supported on a support such as alumina, silica, carbon, or the like, and Group VIII elements of the Periodic Table or compounds thereof such as complexes of rhodium and olefins, chlorotris(triphenylphosphine) rhodium (an Wilkinson catalyst), rhodium (III) acetyl acetonate, or the like. It is preferred to dissolve these complexes in an alcohol solvent, an ether solvent, a hydrocarbon solvent, or the like.

Various blending agents may be added to the fluorocarbon siloxane rubber composition, to the extent that the blending agents do not interfere with the purpose of the present invention, which is to improve solvent resistance. For example, dispersing agents such as diphenylsilane diol, low polymer chain end hydroxyl group-blocked dimethylpolysiloxane, hexamethyl disilazane, heat resistance improvers such as ferrous oxide, ferric oxide, cerium oxide, octyl acid iron, or the like; and colorants such as pigments or the like, may be added as a compounding agent, if necessary.

The fixing belt is obtained by covering the surface of a heat resistant resin or metal belt with the fluorocarbon siloxane rubber composition, and heat and cure it. The composition may be diluted to form a coating solution with a solvent such as m-xylene hexafluoride, benzotrifluoride, or the like. The coating solution is then applied by an ordinary coating method such as spin coating, dip coating, knife coating, or the like. The heat curing temperature and time can be suitably selected. The heat curing temperature and time can be suitably selected within the ranges of 100° C. to 500° C. and 5 seconds to 5 hours, according to a type of the belt, a process for manufacturing the belt, or the like.

A thickness of the layer of fluorocarbon siloxane rubber is not particularly limited. The thickness is preferably 20 μm to 500 μm, and more preferably 40 μm to 200 μm, so as to obtain good fixing properties for an image, with preventing toner separation and offset of the toner at the same time.

The process for image formation to form an image on the electrophotographic image-receiving sheet is not limited to the process mentioned above, as long as it is an electrophotographic process using a fixing belt. Hence, any of the ordinary electrophotographic methods may be used.

For example, a color image may suitably be formed on the electrophotographic image-receiving sheet. A color image can be formed, using an apparatus for electrophotography which permits forming a full color image. An ordinary apparatus for electrophotography comprises an image-receiving sheet transport part, a latent image-forming part, and a developing part disposed in the vicinity of the latent image-forming part. Depending on the type, it may also comprise, in the center of the apparatus, a toner image intermediate transfer part in the vicinity of a latent image-forming part and an image-receiving sheet transport part.

To improve image quality, adhesive transfer or heat assistance transfer methods may be used, instead of electrostatic transfer, bias roller transfer, or in combination of the heat assistance transfer methods, the electrostatic transfer, and/or the bias roller transfer. The detailed structures are described, for example, in JP-A Nos. 63-113576 and 05-341666. The intermediate transfer belt in the heat assistance transfer method is particularly preferred when toner having a small particle diameter is used.

According to the process for image formation of the present invention, separation of the electrophotographic image-receiving sheet and toner or offset of the electrophotographic image-receiving sheet and toners can be prevented, even if an oilless machine providing no fixing oil is used. A stable paper provision can be realized, and a good image with more gloss than ever, and a plenty of photographic features, can be obtained.

The present invention will now be described referring to the detailed examples, but it should be understood that the present invention is not limited to the following Examples.

### EXAMPLE 1

Manufacture of Raw Paper

A broadleaf kraft pulp (LBKP) was beated to 300 ml (Canadian Standard Freeness, C.S.F.) by a disk refiner, and adjusted the fiber length to 0.58 mm. Additives were added in the following proportions to this pulp, based on the mass of pulp.

| Type of additive | Amount (%) |
|---|---|
| Cationic starch | 1.2 |
| Alkyl ketene dimer (AKD) | 0.5 |
| Anionic polyacrylamide | 0.3 |
| Epoxy fatty amide (EFA) | 0.2 |
| Polyamide polyamine epichlorohydrine | 0.3 |

Notes:
AKD is an alkyl ketene dimer (the alkyl part derives from a fatty acid based on behenic acid), and EFA is an epoxy fatty amide (the portion of the fatty acid derives from a fatty acid based on behenic acid).

A raw paper of weighting 150 g/m² was produced from the obtained pulp by a Fortlinear paper machine. 1.0 g/m² of PVA and 0.8 g/m² of CaCl₂were made to adhere to the raw paper by a size press device in the middle of the drying zone of the Fortlinear paper machine.

In the last step of the paper-making process, the density was adjusted to 1.01 g/cm³ using a soft calender. The paper was transported so that the direction (surface) of the raw paper on which the toner image-receiving layer is formed, came into contact with the metal roller. The surface temperature of the metal roller was 140° C. The Oken smoothness of the obtained raw paper was 265 seconds, and the Stökigt sizing degree was 127 seconds.

Preparation of Intermediate Layer Coating Solution

The following components were mixed and stirred so as to prepare an intermediate layer coating solution.

| | | |
|---|---|---|
| SBR resin dispersion | 100.0 | g |
| (solids 50% by mass, Nipol LX-426, ZEON Corporation) | | |
| Thickener (Alcox R-400, MEISEI CHEMICAL WORKS, | 2.0 | g |
| LTD) | | |
| Anionic surfactant (AOT) | 0.2 | g |
| Ion exchange water | 60 | ml |

The viscosity of the obtained intermediate layer coating solution was 85 mPa·s, and a surface tension thereof was 36 mN/m.

Preparation of Toner Image-Receiving Layer Coating Solution

<Titanium Dioxide Dispersion>

The following components were mixed and dispersed using a NIPPON SEIKO NBK-2 so as to prepare a titanium dioxide dispersion (titanium dioxide pigment, 40% by mass).

| | | |
|---|---|---|
| Titanium dioxide | 40.0 | g |
| (Typec (registered trademark) A-220, ISHIHARA SANGYO | | |
| KAISHA,LTD.) | | |
| PVA102 | 2.0 | g |
| Ion exchange water | 58.0 | g |

<Preparation of Toner Image-Receiving Layer Coating Solution>

The following components were mixed and stirred, so as to prepare the toner image-receiving layer coating solution.

| | | |
|---|---|---|
| Aforesaid titanium dioxide dispersion | 15.5 | g |
| Carnauba wax dispersion | 15.0 | g |
| (Cellosol 524, Chukyo Yushi Co., Ltd.) | | |
| Polyester resin aqueous dispersion | 100.0 | g |
| (solids: 30% by mass, KZA-7049, Unitika Ltd.) | | |
| Thickener (Alcox E30, MEISEI CHEMICAL WORKS, LTD) | 4.0 | g |
| Anionic surfactant (AOT) | 0.5 | g |
| Ion exchange water | 20 | ml |

The viscosity of the obtained toner image-receiving layer coating solution (which contained 21% by mass of titanium dioxide, relative to polyester resin) was 50 mPa·s, and a surface tension thereof was 33 mN/m.

Preparation of Backing Layer Coating Solution

The following components were mixed and stirred so as to prepare a backing layer coating solution.

| | | |
|---|---|---|
| Acrylate resin aqueous dispersion | 150.0 | g |
| (solids 30% by mass, DICfine K-96, DAINIPPON INK AND | | |
| CHEMICALS, INCORPORATED) | | |
| Matting agent (Tekpomar MBX-8, Sekisui Plastics Co., Ltd.) | 8.0 | g |
| Releasing agent (Hydrine D337, Chukyo Yushi Co., Ltd.) | 5.0 | g |
| Thickener (Alcox E30, MEISEI CHEMICAL WORKS, LTD) | 0.5 | g |
| Anionic surfactant (AOT) | 0.5 | g |
| Ion exchange water | 40 | ml |

The viscosity of the backing layer coating solution was 60 mPa·s, and its surface tension was 34 mN/m.

Coating of the Intermediate Layer, the Toner Image-Receiving Layer and the Backing Layer

The aforesaid backing layer coating solution was applied to the back surface of the obtained raw paper by a bar coater, then the aforesaid intermediate layer coating solution and the aforesaid toner image-receiving layer coating solution were successively applied to the top surface of the raw paper by the bar coater as in the case of the backing layer.

The intermediate layer coating solution, toner image-receiving layer coating solution and backing layer coating solution were applied so that the coating amounts were 9.5 g/m² in dry mass for the backing layer, 4.5 g/m² in dry mass for the intermediate layer, and 8.0 g/m² in dry mass for the toner image-receiving layer. The thermoplastic resin in the intermediate layer penetrated into the raw paper to 0.8% of the thickness of the raw paper as viewed from the surface.

After application, the backing layer, the intermediate layer and the toner image-receiving layer were dried by hot blast on-line. The air flow for drying and temperature were adjusted so that the back surface, intermediate layer surface and toner image-receiving sheet surface were dried within 2 minutes after application. The drying temperature was set so that the coated surface temperature was identical to the wet-bulb temperature of the drying air.

After drying, calendaring was performed. The calendaring was performed using a gloss calender with the metal roller adjusted to 30° C., and at a pressure of 147 N/cm (15 kgf/cm).

<Evaluation for the Depth of Penetration>

The depth that the thermoplastic resin in the intermediate layer penetrated into each of the obtained electrophotographic image-receiving sheet was measured at a cross-section of the raw paper with a scanning electron microscope. Specifically, the electrophotographic image-receiving sheet was, in a predetermined thickness, sliced in a direction that the thermoplastic resin penetrated into the raw paper. The sliced portions were dyed with dyes that colors only the thermoplastic resin. Thereafter, an enlarged view of the raw paper at a cross-section was obtained. The thickness that the thermoplastic resin in the intermediate layer penetrated into the raw paper was calculated in percentage. The results are shown in Table 2.

<Evaluation of Physical Properties of Electrophotographic Image-Receiving Sheet>

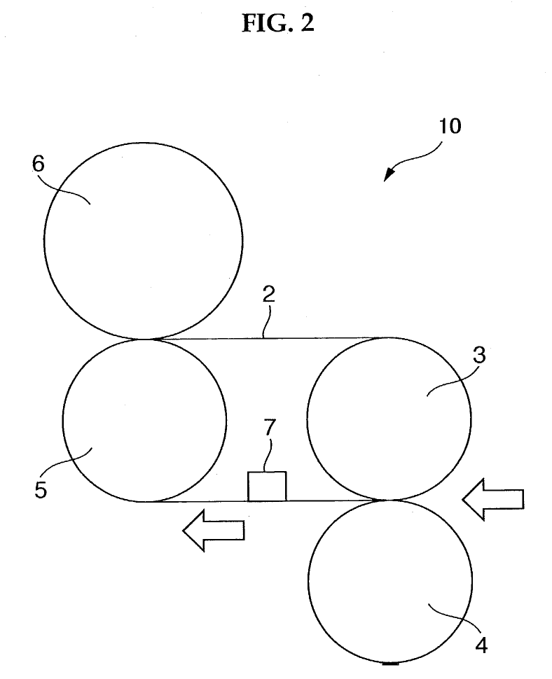

Apart from the use of the fixing belt system 10 shown in FIG. 2, black printing and gray printing with different densities were performed on the surface that receives toner of the obtained electrophotographic image-receiving sheet at 23° C., 55% RH, using a Fuji Xerox Corporation's electrophotographic printer (DocuCentre Color 500CP). After printing, fixing was performed with the printed surface upwards by a belt fixing apparatus shown in FIG. 2, and the brilliance at 20° and brittleness were evaluated. The results are shown in Table 2.

In the fixing-belt system 10 shown in FIG. 2, a fixing belt 2 is suspended around a heating roller 3 and tension roller 5. A cleaning roller 6 is provided above the tension roller 5, where the fixing belt 2 is also provided between the cleaning roller 6 and the tension roller 5, and a pressurizing roller 4 is further provided below the heating roller 3, where the fixing belt 2 is also provided between the pressurizing roller 4 and the heating roller 3. In FIG. 2, the electrophotographic image-receiving sheet having a toner latent image is transported from the right hand side between the heating roller 3 and pressurizing roller 4 so that it is heated and pressurized. It is then transported on the fixing belt 2, and cooled by a cooling apparatus 7 provided downstream along the fixing belt 2. Subsequently, the electrophotographic image-receiving sheet is separated away from the fixing belt 2, and, at the same time, the fixing belt 2 is rotated around the tension roller 5 and is cleaned by the cleaning roller 6.

In the fixing belt system 10, the transport speed of the fixing belt 2 was 30 mm/sec, the nip pressure between the heating roller 3 and pressurizing roller 4 was 0.2 mPa (2 Kgf/cm²), the setting temperature of the heating roller 3 was 150° C., which corresponds to the fixing temperature. The setting temperature of the pressurizing roller 4 was 120° C. The electrophotographic image-receiving sheet was cooled down to 60° C. or less when it was separated from the fixing belt 2.

Base material for the fixing belt was a layer of silicone rubber having a thickness of 40 μm obtained by coating DY 39-115 which is a primer for silicone rubber available from Dow Corning Toray Silicone Co., Ltd., on a base layer of polyimide, drying for 30 minutes in a current of air, forming a coating film by impregnation coating of a coating liquid comprising 100 parts by mass of DY35-796AB which is a silicone rubber precursor and 30 parts by mass of n-hexane, and performing a primary vulcanization at 120° C. for 10 minutes.

A coating film, prepared from 100 parts by mass of SIFEL610 which is a fluorocarbon siloxane rubber precursor available from Shin-Etsu Chemical Co., Ltd., and 20 parts by mass of a mixture of a fluorinated solvent (m-xylene hexachloride, perfluoroalkane and perfluoro (2-butyl tetrahydrofuran)) was then applied to the layer of silicone rubber by impregnation coating, primary vulcanization was performed at 120° C. for 10 minutes, and secondary vulcanization was performed at 180° C. for 4 hours. As a result, a fixing belt having the 20 μm thick layer of fluorocarbon siloxane rubber on the layer of silicone rubber was obtained.

<<Evaluation of Brilliance>>

The brilliance at 20° was measured according to JIS Z8741.

<<Evaluation of Brittleness>>

The aforesaid image that output was left at 23° C., 55% RH for approximately 16 hours, then the electrophotographic image-receiving sheet was wound around a cylinder with showing a surface of the toner image outwards, and was left for 30 seconds. Thereafter, the electrophotographic image-receiving sheet was separated from the cylinder, and it was visibly observed whether or not the toner image had any cracks. Three cylinders were used, and each of these cylinders had diameters of 20 mm, 40 mm and 80 mm, and the evaluation was made in the following four stages:

[Evaluation Criteria]

◯: No visible cracks

Δ: Slight cracks visible

X: Cracks clearly visible

XX: Detachment of toners or toner image-receiving layer observed

The physical properties of each of the layers in the electrophotographic image-receiving sheet were measured using a film (layer) obtained by coating each coating solutions for each of the layers on a Teflon (registered trademark) plate, drying, and separated away from the Teflon (registered trademark) plate.

### EXAMPLES 2-4 and COMPARATIVE EXAMPLES 1-5

Electrophotographic image-receiving sheets according to Examples 24 and Comparative Examples 1-5 were prepared. Depth of penetration, brilliance at 20° and brittleness were measured in an identical way to that of Example 1, except that the conditions shown in the following Tables 1 and 2 were changed. The results are shown in Table 2.

TABLE 1

| | Properties of thermoplastic resin | | | | Properties of polyester | | |
|---|---|---|---|---|---|---|---|
| | in intermediate layer (° C.) | | | | resin in toner image- | | |
| | Type of | | | | receiving layer (° C.) | | |
| | Resin | Tg | Ts | Tfb | Tg | Ts | Tfb |
| Example 1 | SBR | −39 | — | — | 48 | 72 | 104 |
| Example 2 | SBR | 5 | — | 53 | 48 | 72 | 104 |
| Example 3 | NBR | 20 | 45 | 64 | 48 | 72 | 104 |
| Comp. Ex. 1 | Acryl | 51 | 79 | 111 | 48 | 72 | 104 |
| Comp. Ex. 2 | Acr 1 | 67 | 107 | 130 | 48 | 72 | 104 |
| Comp. Ex. 3 | None | | | | 48 | 72 | 104 |
| Comp. Ex. 4 | None | | | | 48 | 72 | 104 |
| Example 4 | SBR | −39 | — | — | 41 | 64 | 87 |
| Comp. Ex. 5 | SBR | −39 | — | — | 28 | 50 | 69 |

Note:
[—] expresses measurements could not be made.

TABLE 2

| | Amount of | | | | | | | |
|---|---|---|---|---|---|---|---|---|
| | thermoplastic resin in | | | | Brittleness | | | Depth of |
| | toner image-receiving | Brilliance at 20° C. | | | 20 mm | 40 mm | 60 mm | penetration |
| | layer (g/m²) | Maximum | Minimum | Δ | (diameter) | (diameter) | (diameter) | (%) |
| Example 1 | 8 | 84 | 79 | 5 | Δ | ∘ | ∘ | 0.8 |
| Example 2 | 8 | 86 | 82 | 4 | Δ | Δ | ∘ | 6.3 |
| Example 3 | 8 | 87 | 84 | 3 | Δ | Δ | ∘ | 7.2 |
| Comp. Ex. 1 | 8 | 91 | 88 | 3 | x | Δ | Δ | 1.5 |
| Comp. Ex. 2 | 8 | 85 | 74 | 11 | xx | x | Δ | 1.2 |
| Comp. Ex. 3 | 8 | 76 | 55 | 21 | xx | xx | x | 0.9 |
| Comp. Ex. 4 | 12 | 81 | 71 | 10 | xx | xx | xx | 0.9 |
| Example 4 | 8 | 83 | 77 | 6 | Δ | ∘ | ∘ | 5.5 |
| Comp. Ex. 5 | 8 | 53 | 21 | 32 | — | — | — | 5.5 |

Note:
[—] expresses surface unevenness is large, and brittleness could not be evaluated.

From the results of Table 1 and Table 2, it was found out that, compared with those in Comparative Examples, an electrophotographic image-receiving sheet which gives a good, high-gloss image and has a toner image-receiving layer with improved brittleness can be obtained, by applying an intermediate layer which contains a thermoplastic resin between a raw paper and a toner image-receiving layer which had a small blended amount of pigment, by the toner image-receiving layer. In the electrophotographic image-receiving sheet thus prepared, a glass transition temperature of the thermoplastic resin in the toner image-receiving layer is 35° C. or more, and is higher than a glass transition temperature of a thermoplastic resin in the intermediate layer.

When this sheet was printed using a commercial color laser printer, specifically a Fuji Xerox Corporation's full color laser printer (DC-2220, DCC-400CP/320CP), all of the sheets was transported therein, and identical results to those of the examples of Table 2 were obtained.

According to the present invention, disposing an intermediate layer having a small blended amount of pigment between a support and a toner image-receiving layer enables flatting irregularities on a surface of the support. As a result, disposing a toner image-receiving layer which contains a thermoplastic resin having a certain glass transition temperature on the intermediate layer enables enhancing brilliance and largely improving brittleness.

What is claimed is:

1. An electrophotographic image-receiving sheet comprising:
a support;
a toner image-receiving layer which contains a thermoplastic resin and is disposed on at least one surface of the support; and
an intermediate layer which contains a thermoplastic resin and is disposed between the support and the toner image-receiving layer,
wherein a glass transition temperature of the thermoplastic resin in the toner image-receiving layer is 35° C. or more and is higher than a glass transition temperature of the thermoplastic resin in the intermediate layer, and the toner image-receiving layer contains less than 40% by mass of a pigment, based on an amount of the thermoplastic resin in mass in the toner image-receiving layer.

2. An electrophotographic image-receiving sheet according to claim 1, wherein the toner image-receiving layer contains 25% by mass or less of the pigment.

3. An electrophotographic image-receiving sheet according to claim 1, wherein the thermoplastic resin in the intermediate layer penetrates into 1% or more and less than 50% of a thickness of the support.

4. An electrophotographic image-receiving sheet according to claim 3, wherein the thermoplastic resin in the intermediate layer penetrates into 0.01% or more and less than 1% of the thickness of the support.

5. An electrophotographic image-receiving sheet according to claim 1, wherein at least one of the thermoplastic resin in the intermediate layer and the thermoplastic resin in the toner image-receiving layer is a self-dispersing water-dispersible polyester resin emulsion, which satisfies the following properties (1) to (4):
(1) Number average molecular weight (Mn)=5000 to 10000
(2) Molecular weight distribution (weight average molecular weight/number average molecular weight)≦4
(3) Glass transition temperature (Tg)=40° C. to 100° C.
(4) Volume average particle diameter=20 nm to 200 nm.

6. An electrophotographic image-receiving sheet according to claim 1, wherein the toner image-receiving layer further contains natural wax, and the natural wax is one of vegetable wax and mineral wax.

7. An electrophotographic image-receiving sheet according to claim 1, wherein the vegetable wax is carnauba wax having a melting point of 70° C. to 95° C.

8. An electrophotographic image-receiving sheet according to claim 1, wherein the mineral wax is montan wax having a melting point of 70° C. to 95° C.

9. An electrophotographic image-receiving sheet according to claim 1, wherein the support is selected from raw paper, synthetic paper, a synthetic resin sheet, coated paper, and laminated paper.

10. An electrophotographic image-receiving sheet according to claim 1, wherein the toner image-receiving layer receives toners, and the toners contain a binder resin and a colorant, the toners have an average particle diameter of 0.5 μm to 10 μm and a volume average particle size distribution index (GSDv) of the toners of 1.3 or less.

11. An electrophotographic image-receiving sheet according to claim 10, wherein a ratio (GSDv/GSDn) of the volume average particle size distribution index (GSDv) and a number average particle size distribution index (GSDn) of the toners is 0.95 or more.

12. An electrophotographic image-receiving sheet according to claim 10, wherein the toners have the volume average particle diameter of 0.5 μm to 10 μm, and an average value of a formation coefficient of the toners expressed by the following formula is 1.00 to 1.50;
Formation coefficient=(π×L²)/(4×S)
where “L” expresses a maximum length of one of the toners, and “S” expresses a projected area of one of the toners.

13. An electrophotographic image-receiving sheet according to claim 10, wherein the toners are manufactured by a process comprising the steps of:
(i) forming aggregated particles in a dispersion in which resin particles are dispersed, so as to prepare aggregated particle dispersion;
(ii) adding and mixing a fine particle dispersion in which fine particles are dispersed, into the aggregated particle dispersion, so as to form adhesion particles in which the aggregated particles adhere to the fine particles; and
(iii) heating and fusing the adhesion particles, so as to form toners.

14. A process for manufacturing an electrophotographic image-receiving sheet comprising the steps of:
applying an intermediate layer coating solution on a support so as to form an intermediate layer;
applying a toner image-receiving layer coating solution on the intermediate layer so as to form a toner image-receiving layer,
wherein the electrophotographic image-receiving sheet includes the support, the intermediate layer, and the toner image-receiving layer in this order, and the electrophotographic image-receiving layer comprises:
the support;
the toner image-receiving layer which contains a thermoplastic resin and is disposed on at least one surface of the support; and
the intermediate layer which contains a thermoplastic resin and is disposed between the support and the toner image-receiving layer,
wherein a glass transition temperature of the thermoplastic resin in the toner image-receiving layer is 35° C. or more and is higher than a glass transition temperature of the thermoplastic resin in the intermediate layer, and the toner image-receiving layer contains less than 40% by mass of a pigment, based on an amount of the thermoplastic resin in mass in the toner image-receiving layer.

15. A process for manufacturing an electrophotographic image-receiving sheet according to claim 14, wherein the intermediate layer coating solution has a viscosity of 30 mPa·s or more.

16. A process for manufacturing an electrophotographic image-receiving sheet according to claim 14, wherein the intermediate layer coating solution has a surface tension of 39 mN/m or less.

17. A process for manufacturing an electrophotographic image-receiving sheet according to claim 14, further comprising a step of:
calendaring the electrophotographic image-receiving sheet,
wherein the step of calendaring is carried out after the step of applying a toner image-receiving layer coating solution.

18. A process for image formation comprising the steps of:
forming a toner image on an electrophotographic image-receiving sheet;
heating and pressurizing a surface of the electrophotographic image-receiving sheet on which the toner image is formed by a fixing belt and a fixing roller; and
cooling the surface so as to separate the electrophotographic image-receiving sheet from the fixing belt,
wherein the electrophotographic image-receiving sheet comprises:
a support;
a toner image-receiving layer which contains a thermoplastic resin and is disposed on at least one surface of the support; and
an intermediate layer which contains a thermoplastic resin and is disposed between the support and the toner image-receiving layer,
wherein a glass transition temperature of the thermoplastic resin in the toner image-receiving layer is 35° C. or more and is higher than a glass transition temperature of the thermoplastic resin in the intermediate layer, and the toner image-receiving layer contains less than 40% by mass of a pigment, based on an amount of the thermoplastic resin in mass in the toner image-receiving layer.

19. A process for image formation according to claim 18, further comprising the step of:
fixing the toner image,
wherein the step of fixing is carried out by a heating roller, and is carried out between the step of forming and the step of heating and pressurizing.

20. A process for image formation according to claim 18, wherein the step of cooling is carried out by cooling the toner image to one of a melting point or lower of a binder resin contained in a toner of the toner image, and a glass transition temperature plus 10° C. or lower of the binder resin.

21. A process for image formation according to claim 18, wherein the fixing belt has a layer of fluorocarbon siloxane rubber on a surface thereof.

22. A process for image formation according to claim 21, wherein the fluorocarbon siloxane rubber has at least one of a perfluoroalkylether group and a perfluoroalkyl group in a main chain thereof.

23. A process for image formation according to claim 18, wherein the fixing belt has a layer of silicone rubber on a surface thereof, and a layer of fluorocarbon siloxane rubber on the layer of silicone rubber.

24. A process for image formation according to claim 23, wherein the fluorocarbon siloxane rubber has at least one of a perfluoroalkylether group and a perfluoroalkyl group in a main chain thereof.
